(19) United States
(12) Patent Application Publication
(10) Pub. No.: US 2005/0004942 A1
(43) Pub. Date: Jan. 6, 2005

(54) Methods and systems for controlling network infrastructure devices

(76) Inventors: Mark E. Madsen, Seattle, WA (US); Christopher D. Wheeler, Seattle, WA (US); Shaw C. Chuang, Mountain View, CA (US); Timothy D. Hinderliter, Seattle, WA (US); Alx V. Dark, Seattle, WA (US); Christine Windsor, Sammamish, WA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/817,157

(22) Filed: Apr. 2, 2004

Related U.S. Application Data
(60) Provisional application No. 60/460,072, filed on Apr. 2, 2003.

(51) Int. Cl. G06F 7/00

(52) U.S. Cl. 707/104.1

(57) ABSTRACT

A network management system is provided that allows a user to configure multiple devices according to a consistent set of policies. The system includes a device learning module that can read configuration data from a network device and automatically match that configuration data to existing policies and components of policies within the system. The device learning module also identifies unknown configuration data, which does not match any existing policy. The system further includes a grammar builder that can parse the unknown configuration data and construct a component or policy from the unknown data, by matching the unknown data to a grammar of configuration commands for the network device. The system also provided auditing capabilities, where policies are compared to running network configurations, and differences are identified.

This application claims the benefit of U.S. Provisional Application No. 60/460,072 filed on Apr. 2, 2003, which prior application is hereby incorporated by reference in its entirety as if fully set forth herein.

### BACKGROUND OF THE INVENTION

Enterprise networks today are composed of hundreds to thousands of network devices arranged in such a way as to connect sites together, and provide both internal network resources as well as Internet access to employees. Service provider networks are even larger, often composed of tens of thousands of network devices. These devices include routers, LAN switches, and firewalls, in addition to other types of specialized devices (e.g., bandwidth performance measurement and control, traffic “load balancers,” etc.).

Virtually none of these devices are functional within the network when removed from their shipping boxes. Each device has the hardware necessary to perform its function, and each device typically has software which handles any higher-level processing as well as presenting a configuration interface to users. Generically, this software is referred to as the device's “operating system”. For some devices, the operating system presents few options to the user and thus requires little setup before the device is functional within the network; an example would be the low end LAN Ethernet switches which are ubiquitous in many networks today. For higher-end devices, such as those which run the “backbone” of most enterprise or Internet networks, or devices within the corporate data center, the operating system can present a truly vast array of options which govern device functionality. These options generally must be configured by the user before the network device is useable.

Routers and switches from vendors such as Cisco Systems, for example, can require tens to thousands of individual configuration commands in order to function within the network. At the simplest level, the number and combination of commands required on a specific device is a function of its role in the network, the network protocols used, the number and type of connections handled by the devices, and security measures employed on the network.

The process for creating these configurations starts with the overall network design, which is often expressed by network engineers in diagrams of the physical network along with knowledge of which network protocols and other functionality is in use. Within organizations with more rigorous standards, configurations for classes of devices are often “templated,” with examples of configurations set up by senior engineers and then used (with appropriate device-specific data) by engineers in the field who deploy and maintain devices. Templates may be stored in a version-control system, in order to track changes. In less rigorous organizations, templates may merely be word-processor documents or memos which outline standards for device configuration.

Once configurations are designed for each network device, the commands making up the configuration must be applied to the device itself. Several mechanisms exist for doing so, ranging from typing the configuration commands into the device's command-line interpreter to a number of ways to “download” the configuration commands all at once (TFTP, FTP, Secure Shell copy, etc). This process is then repeated for all devices that need to be updated.

The processes described above are tedious, time-consuming, and error-prone. Attempts have therefore been made to automate the routine aspects of these processes. Nearly every large network engineering organization, for example, will likely possess “scripts” or small programs—typically written in-house—to retrieve and possibly even “download” configurations to multiple devices, change passwords, or construct lists of devices and configurations. Scripts of this type simply replace the repetitive aspect of logging in to many devices and typing the same commands repeatedly.

Commercial attempts to automate device configuration essentially start from this basis. Tools such as Resource Manager Essentials (part of the CiscoWorks family of network management applications) provide access to the configuration text within a web browser interface, and allow any edits to be easily deployed to the running network device. Such systems typically also save each version of a configuration and allow users to view this history, displaying differences between configurations in a visual format; history is also useful for rolling back to an earlier configuration version and effectively erasing mistakes within the network.

In the description above, no mention was made of providing tool support during the process of designing the configuration. The simplest device configuration systems don't provide such support. Designing network configurations is left to engineers to work out by traditional methods, and then the design is manually translated into individual configurations. The applications simply allow the engineer to edit the configurations safely—i.e., within the context of the tool, before it is distributed to the network devices themselves. The simplest applications also manage devices individually—in other words, if changes need to be made to 100 device configurations, the tool would be used 100 times to edit 100 individual configurations. This may provide the safety of working offline but it does not make the process any more efficient.

One approach to providing efficiency is to allow a common set of commands to be deployed to many devices at the same time, achieving a form of mass configuration. This capability goes by many names commercially (e.g., Command Sets in Intelliden's product), and is referred to as a “template” herein. In the simplest implementations, templates are a set of complete commands (i.e., with data values filled in) which can be deployed to a set of network devices. In more complex implementations, templates may allow “variables” which serve as placeholders for data which need to be filled in based upon the individual device. Often, the user is prompted to fill in data values for each device, or provide a list of values.

Several limitations exist for the “pure template” approach as described above. With templates that are composed of complete configuration commands, it is difficult to create a well-factored set of truly generic templates which can reflect your network design in a “normalized” fashion. The term “normalization” is borrowed from the field of database design, and refers to the situation that exists when each piece of data is reflected in only one place within the database, and all pieces of data may be retrieved by a single well-defined query (however complex it might turn out to be). Normalization is an important goal for network configuration as well, because it reflects the state when each piece of network functionality can be changed with the minimum of effort and the minimum impact on unrelated devices or functions.

In a generic or “normalized” set of configuration templates, each aspect of the network design would exist in a single place. All devices which incorporated that aspect of network functionality could be updated by editing and re-deploying that template. In order to accomplish this, templates cannot simply contain configuration commands; two other capabilities are useful in order to achieve full normalization.

First, templates should not incorporate complete commands, but should instead be somewhat abstract. This capability allows templates can be adapted to the specific devices onto which the functionality will be deployed. The user experience may or may not be wholly abstract, but the underlying template should be stored as abstract versions of commands, with a process to translate them into final configuration commands appropriate to each device.

Second, templates should allow for data references and queries with a sufficiently rich ability to cross-reference data within and between devices. This allows an abstract template (as discussed above) to incorporate data values which are appropriate to a given device—nothing need be “hard-coded.” This capability allows each piece of data (e.g., an Ethernet interface IP address) to exist in one location, and simply be referenced everywhere else. Whenever such a source behind a reference changes, each reference to that data should be updated as well.

Thus there is a need for systems and methods of providing a normalized management of network designs and configurations, and allowing technologies for design to be algorithmically linked to actual device configurations.

### SUMMARY OF THE INVENTION

In an embodiment, software systems and methods for managing the configuration devices on a network, through subscriptions to a common database of policies, are disclosed. These policies are an embodiment of “normalized” configuration templates as discussed in the previous section; policies thus adapt themselves to the specific device being configured, and can allow for device-specific data references and queries.

Embodiments of the invention also maintain control over policy and data modifications, providing a complete version history for each element managed in the database. The method of an embodiment is thus a policy-driven or policy-based method for managing network device configurations. The system also incorporates a method for automatically updating the database of policies, using a learning system that incorporates new syntax whenever encountered.

The system of an embodiment also provides capabilities that bridge the gap between configuration control and network monitoring. Because the system can analyze a native device configuration and return the list of policies implemented, it can continually re-analyze devices and monitor changes to devices at the policy level. Using this technology, the system alerts users when devices fail to implement the intended policies or when changes made outside the system, such as manual changes made by network engineers, cause divergence among devices.

Additionally, embodiments of the invention are designed to overcome the limitations of a “pure template” approach, provide “normalized” management of network designs and configurations, and allow technologies for design to be algorithmically linked to actual device configurations.

Another aspect of an embodiment of the invention is the degree to which the structure of the configuration, as well as the semantics of configuration commands, are parsed and understood by the automation tool. Earlier approaches to the problem treat commands and lo configurations as blocks of text which have meaning to the human user, and to the network device, but not to the automation tool. Another aspect of an embodiment of the invention is that device configurations are written in a “regular language,” and thus are amenable to the standard tools of linguistic parsing, analysis, and generation.

Configuration comprehension is realized in an embodiment of the invention by the use of a compiler which handles both the incoming parsing of native configurations and outgoing production of new native configurations. Because embodiments of the invention are designed to control many different types of hardware from multiple vendors, this compiler is modular, allowing the same “source code” (e.g., a tree of configuration elements) to be translated into different “executables” (e.g., the specific configuration languages of different vendors).

Some vendors (e.g., Cisco Systems) have many product lines, often with different operating systems and different command languages. Each vendor (and operating system) supported by embodiments of the invention thus has a formal grammar, which was initially produced by hand. For each unique combination of vendor and language, a formal grammar and methods for interacting with the device to retrieve and update configurations are used.

In addition, aspects of embodiments of the invention allow grammars to be extensible at runtime, since vendors frequently add new commands whenever new hardware or new functionality appears within a product line. Within embodiments of the invention, grammars are expandable without additional programming, because the parser is designed to recognize (and isolate for analysis) sections of native configurations which do not match any known device configuration command. Segments of native configuration representing unknown syntax can then be turned into full grammar through a system for discovering and automatically writing new grammar segments. These new grammar segments can then be inserted into the grammar database and used immediately for parsing incoming native configurations or compiling new configurations for output to a network device.

At a high level, the system of an embodiment can be broken into two major functional areas. First, the system allows large numbers of network devices to be configured and controlled using flexible policies which are easily created by users of the system without writing any programming code or understanding the inner workings of parsers or compilers. Second, the system incorporates innovations that are designed to automatically incorporate new information about changes that hardware vendors make to their product lines, without requiring an update to the system code.

### DESCRIPTION OF THE DRAWINGS

The accompanying drawings are included to provide a further understanding of embodiments of the invention and together with the Detailed Description, serve to explain the principles of the embodiments disclosed.

FIG. 1 depicts a network management system in accordance with an embodiment of the invention.

FIG. 2 depicts an instance tree for a policy-driven configuration.

FIG. 3 depicts a policy for use with a policy-driven configuration.

FIG. 4 depicts a native configuration as parsed by the device learning system of an embodiment of the invention.

FIG. 5 depicts the stages of parsing a native configuration into a policy-driven configuration according to an embodiment of the invention.

FIG. 6 depicts a method of parsing a native configuration.

FIG. 7 depicts a method of identifying policies contained in a parsed configuration.

FIG. 8 depicts a method of handling parsing errors.

FIG. 9 depicts an instance tree containing recognized components and unknown regions.

FIG. 9A depicts an unknown region contained within a recognized component.

FIG. 10 depicts a method of processing an instance tree to recognize candidate components.

FIG. 11 depicts a generalized method of resolving candidate components into components.

FIG. 12 depicts a method of creating an abstract syntax tree for a command root.

FIG. 13 depicts an abstract syntax tree created according to the method of FIG. 12.

FIG. 14 depicts a method of transforming an abstract syntax tree into a grammar for a component.

FIG. 15 depicts a method of identifying command boundaries within a grammar tree.

FIG. 16 depicts a method of discovering command-level semantics caused by alterations to configurations.

FIG. 17 depicts a method of identifying default values and equivalencies in command attributes.

FIG. 18 depicts a method of identifying attributes which can create unique instances of a component.

FIG. 19 depicts a method of identifying addition dependencies in a configuration.

FIG. 20 depicts a method of identifying removal dependencies in a configuration.

FIG. 21 depicts a component having multiple alternative sets of syntax blocks.

FIG. 22 depicts a method of compiling a policy-driven configuration into a native configuration.

FIG. 23 depicts a method of applying a native configuration to a network device.

FIG. 24 depicts a method of auditing a native configuration against a policy-driven configuration, to detect differences between the two.

FIG. 25 depicts a method of auditing a native configuration to ensure network design consistency is maintained.

### DETAILED DESCRIPTION OF THE PREFERRED EMBODIMENTS

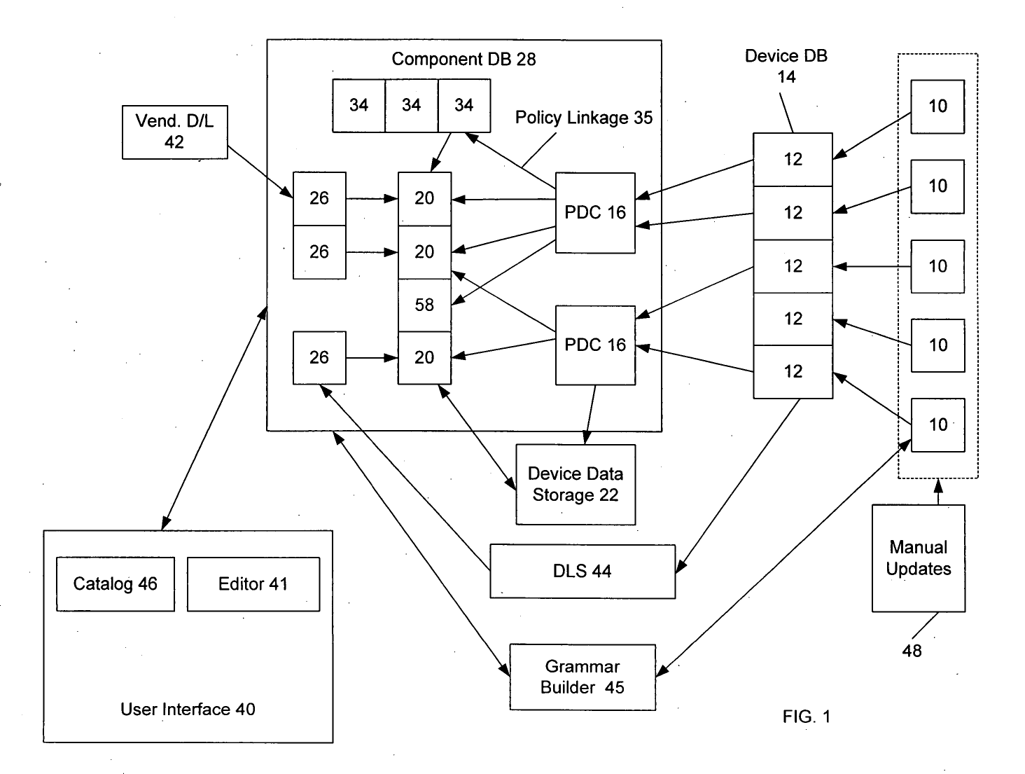

In the system of an embodiment shown in FIG. 1, network device data structures 12 are data structures that represent physical devices 10. Examples include routers, switches, or firewalls. Each physical network device 10 is represented by a network device data structure 12, s which is stored in the network device database 14. Customers purchase a software license which enables a fixed number of device data structures 12 to be created and stored in the device database 14. Additional licenses to create and store device data structures 12 can be purchased throughout the lifetime of the product. Each device data structure 12 contains metadata (information) concerning that device 10, such as information about the device vendor, software operating system or command language version, and the appropriate methods and authentication credentials for executing commands on the device 10. Each device data structure 12 also contains a native configuration for the associated network device 10. Furthermore, the network device data structure contains pointers to user-created metadata about the device. These metadata include categories and groupings useful for organizing a large number of devices, as well as for creating policies.

Each network device 10 is associated, via a network device data structure 12, with zero or more Policy-Driven (“PD”) configurations 16, each of which represents a complete set of directives needed for the physical network device 10 to function in an intended manner. These PD configurations 16 are stored in a component database 28. In an embodiment, a network device has one “active” configuration at any time, and the user can switch active status between any of the stored PD configurations 16 associated with a device 10 at any point in time. In an alternate embodiment, a network device 10 can have more than one active configuration 16.

Policy-driven configurations 16 are data structures which represent the total desired state of a network device 10 within the system. PD configurations 16 contain references to a set of instances 20, policies 34, and device data stored in persistent storage 22. The instances 20 are stored in the component database 28.

In terms of implementation, PD configurations 16 are a set of references or pointers to instances 20 of components 26 stored elsewhere in the component database 28, or policies 34. Components 26 are not directly used by device configurations 16. Instead, following object-oriented practice, “instance” objects, i.e. instances 20, are created whenever a component 26 is attached to a PD configuration 16. Instances combine a reference to a component 26, and device-specific data stored in the device data storage 22. Policies 34 are persistent groups of instances 20 which can be reused across many PD configurations 16.

If an instance 20 is created purely to serve within the context of a single device 10, the system creates a “private” or anonymous instance 20 of the component 26, which contains both syntax and references to device-specific data which are retrieved from storage 22 in the process of resolving data references set up in the grammar. Private instances do not show up in the catalog 46 of components displayed to the user for reuse, since private instances are not reusable.

If an instance 20 is created to be used on more than one device 10, the system creates a policy 34 which is a public instance of the component. Policies may be reused on any number of devices 10, and may include entire collections of instances 20 and data references. Policies thus act like “templates” which aggregate together functionality, saving manual configuration effort and increasing consistency and accuracy across the customer's network. Policies are displayed in the catalog 46 of components for use by the user, and stored in the component database 28.

Some of these data references may be partially filled because their values are not device-specific (e.g., routing protocol parameters which are constant across devices but need to be customized for the user's particular network), while other data references are resolved for each device configuration 16 to which the policy 34 is attached.

Policies 34 are the means by which configurations can be factored into larger-scale units and reused. Policies 34 create a “change once, apply everywhere” semantic to network device configuration, and are the principal mechanism for decreasing the effort required to run a network using the system. When policies 34 are added from PD configurations 16, we keep a database record of the policy linkage 35. This linkage is used in advanced device monitoring and auditing, as described below. When a policy 34 is removed from PD configurations 16, the appropriate policy linkage 35 is removed from the database record of policy linkages.

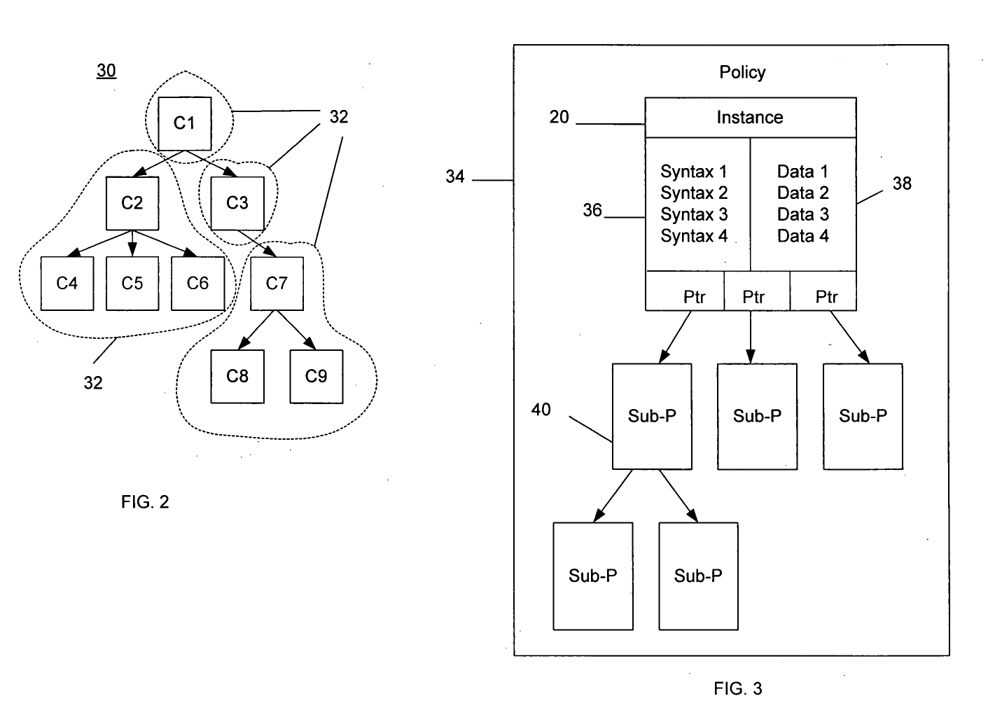

Turning to FIG. 2, instances 20 in a PD configuration 16 are organized in a strict tree 30 which organizes instances 20 into a series of containers 32 which correspond to vendor-neutral or abstract networking concepts. This tree 30 does not necessarily correspond to the topology of the actual grammar of the vendor's command language as stored in the totality of syntax blocks stored in instances 20. The mapping between the two is handled by custom directives embedded in a grammar specification language, which allow reorganization of the component tree 30 along with subsequent compilation using the “correct” set of syntax (derived from the instance tree 30), as discussed in detail below. The containers 32 are present in the catalog 46 of components and policies, and are used to construct a human-readable representation of the catalog within the user interface 40.

Turning to FIG. 3, a policy 34 represents a reusable set of instances 20. At the top of FIG. 3, a single instance 20 is expanded to show its internal structure. Within the instance 20, is a collection of syntax blocks 36, for example one or more configuration directives, possibly associated with configuration data 38. Policies 34 may contain other policies as well, which means that an instance often points to zero or more child sub-policies 40. When compiled into a native configuration, instances 20 and any sub-policies 40 which are included in a policy 34 are compiled. This behavior allows the creation of reusable policies which lessen the work required to create standardized sets of network devices.

At the lowest level, the system of an embodiment contains a set of component syntax blocks 36 for a given network device vendor or configuration language. These components are an object-oriented view of the grammar specification for a given configuration language, and as such are abstract. In other words, device-specific data 38 is usually not associated with the component syntax blocks 36. In alternate embodiments, however, device-specific data 38 may be associated with a component syntax block 36, for example if the configuration language itself is device-specific. References to device-specific data 38 are denoted in the syntax block 36 by a “variable” or “placeholder” grammar construct that indicates that a position within the syntax block 36 is to be filled in with the results of a database query into device data storage 22, for example when the component 26 containing the component syntax block 36 is instantiated into an instance 20. Component syntax blocks 36 are editable using a component editor 41 within the user interface 40 using a simplified graphical method for adding, deleting, and modifying syntax block elements.

Component syntax is created in several ways—by direct creation within the user interface 40 using a component editor 41, by downloads 42 received from an outside source such as a manufacturer of the system or a third party component creator, or by Grammar Builder 45. Grammar Builder 45 allows the system to “learn” new syntax by analysis of candidate components 58 for syntax that is not recognized as part of the existing component database 28. Grammar Builder 45 is described in detail below.

Physical devices 10 possess a single running configuration at any one time—the set of commands, language directives, and data used by onboard operating system software or firmware to produce the running behavior of the device. This is referred to as a “native configuration”. Some devices can store alternative configurations in memory or persistent storage (e.g., Cisco IOS devices store startup configurations in NVRAM, and these can be separate in some cases from the running configuration in RAM). Native configuration refers to the set of commands, directives, and data stored on a physical device, whether running or alternate. Native configurations are retrieved, stored in the device data structures 12, and analyzed during device registration, and are created by the DLS 44, for loading onto the network device 10, when compiling a PD configuration 16 during preview or task execution. Native configurations may also be revised directly on the network device 10, for example by an engineer performing a manual update 48. Manual updates may occur during troubleshooting or in order to install a change recommended by the network device vendor.

Policy-driven configurations 16 (as well as components and data) are version-controlled within the system. These entities are edited by checking out the entry into a local working area within the user interface 40. This working area is referred to as a “workspace,” and workspaces can be personal or shared by a group of users for collaborative work. Entities which are edited within a workspace are then checked in, creating a new persistent version of the entity. Users can browse the history of each entity, and roll back the current state of an entity to a previously stored version.

Editing is done in the context of a “job”, which serves as a container within the user interface 40 for organizing the work needed for accomplishing a real-world project. Examples of projects range in scope from “deploying a new Ethernet switch” to “create an enterprise-wide mesh of VPN tunnels.” Projects begin with the editing of entities within a workspace—for example, PD configurations 16 or policies 34, and are finished when each device 10 requiring update has received the changes which result from such edits.

Within a job, edits to a policy 34 may affect many different network devices. Dependencies between network devices and policies 34 are maintained within the system (as a series of policy linkages 35), so that a task may be created for each device 10 affected by edits to a policy 34. Changes to private instances 20 within a PD configuration 16 also trigger the creation of a task for updating the network device 10. Tasks are workflow items, owned by a user of the system and requiring resolution before a job is completed.

The system of an embodiment is designed to automatically track changes made by network hardware vendors to their command languages and syntax. Previously, products either forced the human user to track vendor changes, or wait for the software solution vendor to produce product updates.

The process of importing network devices 10 into the system may involve both making entries into a device and license inventory database 14, and the retrieval and analysis of the native configuration running on the device 10 at the time of import. The latter activity is performed by the Device Learning System 44, as discussed in detail below.

The database 14 of basic device information is a standard SQL database used to record the name and other metadata concerning each network device 10. Examples of metadata include the location and model number of each network device 10. These metadata are used for grouping and sorting functions within the system's user interface 40.

In an embodiment, entries made in the device inventory database 14 are tracked against the customer's purchased license. A “grace period” is activated when the inventory reaches the total purchased license, allowing the customer to exceed their paid license account for a temporary interval while they acquire additional licenses from the system vendor. This feature is for customer convenience, and can be disabled within the system if deemed desirable.

Importing native configurations from the running device 10 accomplishes two goals. First, import of the existing native configuration saves a significant amount of re-work by customers, thus easing adoption and speeding the utility of the system for customers. Second, importation and subsequent analysis of the parsed configuration is useful in Grammar Builder 45—which allows for extending the database 28 of components and policies without significant manual effort on the part of the customer or vendor.

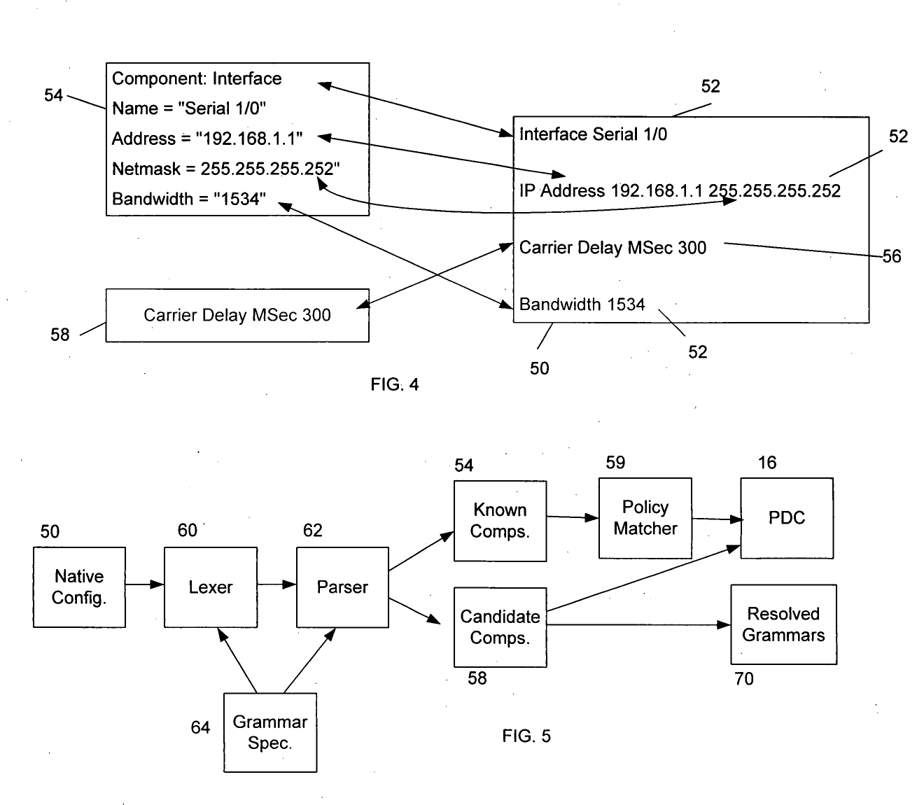

Turning to FIG. 4, in an example of the operation of the Device Learning System 44, a native configuration 50 imported from a running network device 10 will contain sets of configuration commands 52 that already exist in recognized component form 54 within the system, as well as some constructs 56 which are not represented by recognized components 54. Those constructs 56 which are not represented by recognized components 54 are subsumed by candidate components 58 which can be later analyzed by Grammar Builder 45.

Turning to FIG. 5, a high level view of the stages of the Device Learning System 44 are shown. The Device Learning System 44 begins with the native configuration 50 as an input. The native configuration 50 is provided to a lexer module 60, where each of the literal strings in the native configuration 50 is assigned a token ID (tokenized). The tokenized configuration is emitted as a data stream to a parser 62, which parses the configuration into either recognized components 54, or candidate components 58. The parser 62 is configured using the components 26 in the component database 28, such that the parser will recognize any components in the native configuration 50 which match components 26 stored in the component database 28. The lexer 60 is also configured using the components in the component database 28, such that the lexer 60 will recognize the tokens used in the grammar embodied in the components 26. Then, the set of components is analyzed by policy matcher 59 to determine which, if any, policies 34 are represented. The result of Device Learning System 44 analysis is a Policy Driven Configuration 16 and zero or more candidate components 58.

Configuration analysis and configuration compilation use the same parsing engine. This is done to allow the component structure to be used symmetrically—either in parsing and analysis of an existing device 10, or to be used as a specification for emitting a new native configuration 50 at compile time. In an embodiment, the parsing engine uses a custom grammar specification language discussed below, rather than a YACC-style grammar specification. Alternatively, a YACC-style grammar specification may be used.

The custom grammar specification language of an embodiment uses a very close coupling of the lexing (tokenization) and parsing functions in order to deal with complex configuration languages—many of which were not “designed” but rather evolved over many releases. In contrast to a typical YACC-style grammar specification, where semantic actions are explicit within the grammar, the custom grammar specification language avoids explicit semantic actions in order to use the same grammar specification for both analysis and configuration compilation. Semantic actions refer to the code executed when a specific syntactic construct is matched by the parser 62—the action might be to insert the parsed data into a data structure, or to execute some application functionality, for example. The custom grammar specification closely couples the lexer and parser in order to implement one step in the analysis of candidate components 58.

Within the system, semantic actions are left implicit in the grammar specification, and are inferred based on the type of parser being constructed—an analysis parser 62 (for analyzing existing configurations) or a compiler (for creating configurations from components). In the case of an analysis parser 62, semantic actions include creating an in-memory tree representation of the configuration syntax, along with “actions” which reorganize the tree and insert parsed data into the appropriate class objects as member variables. In the case of a generated compiler, semantic actions include resolving data references and emitting “instructions” in the form of syntactically correct configuration commands in the relevant device vendor's language (e.g., Cisco IOS).

In order to create a learning effect, the analysis parser 62 is freshly constructed prior to importing the native configuration 50 from a new device 10 (although caching can be used as an optimization where appropriate). In other words, the contents of the component database 28 are used to construct the lexer 60 and parser 62 anew for each run. This means that as components 26 are added—either directly in the GUI or through Grammar Builder 45—the parser 62 becomes incrementally richer and better able to recognize the user's configurations at a component or policy level.

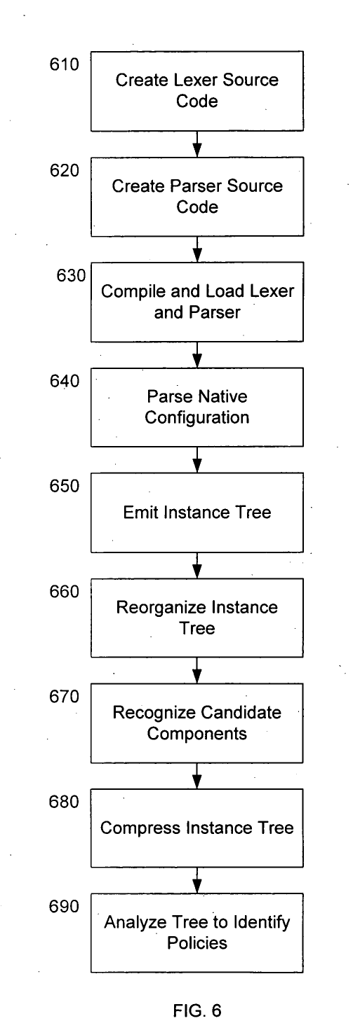

With reference to FIG. 6, in the first step 610, the grammar specification (in NC format) is scanned to develop a mapping of literal strings into lexer tokens. This mapping is used to generate the source code for the lexer module 60, which is used by the parser 62 to scan the native configuration text at a low level and return a stream of tokens rather than literal ASCII text. Both the lexer 60 and parser 62 source code are created by combining the processed grammar specification with source code templates which contain common constructs which are invariant from run to run of the system.

In the second step 620, the source code for the parser 62 is generated, by iterating over the grammar rules contained in each component 26 and creating a YACC-compliant rule. For each grammar rule contained in each component 26, the system generates a YACC rule which matches tokenized syntax seen in the configuration being analyzed. The system also generates an appropriate semantic action for each rule. In the case of configuration analysis, semantic actions involve instructions for building an in-memory representation of instances of recognized components 54 as well as insertion of data into objects as member variables, plus some reorganization of the resulting “instance tree.” Grammar rules are sometimes rewritten to turn the more compact and expressive Extended Bakus-Naur Form (EBNF) syntax specifications into YACC-style BNF (Bakus-Naur Form) specifications. Rewriting is done whenever necessary.

Once the source code for the lexer 60 and parser 62 are generated, at step 630 each is compiled and then dynamically loaded by the Device Learning System 44. The system is now ready to the parse the native device configuration 50, which has been previously retrieved. The generated parser may be LALR (Look Ahead, Left Recursive), or alternatively may be a GLR (Generalized Left Recursive) parser, in order to allow resolution of certain ambiguous command syntaxes found in some native configurations.

At step 640, the parser 62 is run with the native configuration 50 as input, with parsing occurring in a fairly normal fashion, except for handling of parse errors. As the parser 62 receives a stream of tokens from the lexer 60, it matches sequences of tokens which form rules in the grammar which was synthesized from the current state of the component database 28.

Each rule corresponds to the syntax 36 of a single component 26, expressed in YACC-style specification. When a rule is matched in the native configuration input, a component instance object is created and added to an instance tree maintained by the parser 62. In addition, semantic actions are triggered which handle additional instance construction activities, such as copying parsed data values into object member variables.

In conventional parsing implementations, a parse error would indicate that the parser 62 encountered syntax which is illegal given the parser's grammar definition. In the parser 62 of an embodiment, since the parser grammar is generated from the library 28 of components, parse errors represent configuration commands that are not yet part of the component database 28. Thus, parser exceptions which result from unknown grammatical constructs are handled in a separate step, to create candidate components 58 before the configuration is given to the user for viewing and editing. Recognition of candidate components 58 through parse error handling is described in detail below.

Once the parser is finished parsing the native configuration 50, at step 650 it returns a data structure called an “instance tree.” This data structure contains instances 20 which house not only the parsed syntax but also named member variables that were recognized during parsing, organized in strict conformance to the topology of the original grammar specification.

The instance tree is relatively flat after parsing, and thus is reorganized along a number of dimensions at step 660. Hints in each component's stored syntax are used to move instances around within the instance tree. This is done, for example, to group together related instances (e.g., ACL entries, routing advertisements). Tree reorganization serves to both enhance user comprehension, and also provide hooks for implementation of vendor-neutral component relationships and other post-processing based on metadata. Following recognition of candidate components 58 at step 670, the tree is then compressed to remove empty instances following reorganization and generally collapse redundancies at step 680. Again, this is done both to enhance user comprehension, and also to provide a post-processing hook for cleanup following other post-processing based on metadata.

Finally, at step 690 the instance tree is analyzed at the policy level to detect nodes which represent instances of policies 34 stored in the component library 28. Policy analysis begins with the instance tree as it exists after parsing and reorganization. This instance tree contains references to base components 26 and associated data found during parsing. At the level of policies, which can span many devices, none of the recognized components 54 recognized during parsing are yet understood.

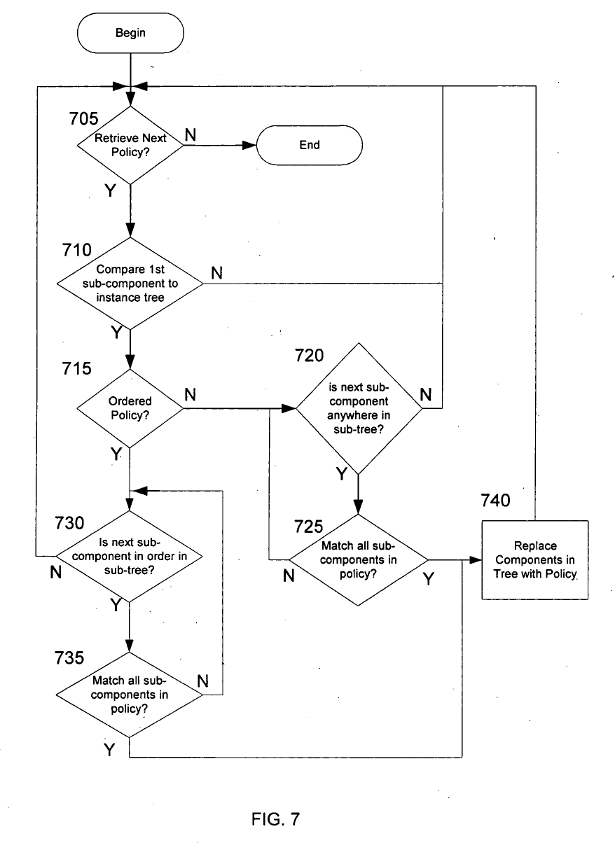

Recognition of policies occurs by attempts to match policies against the instance tree, as shown in the method of FIG. 7. For each policy 34 stored in the database 28 and retrieved at step 705, we attempt to match the first sub-component contained in the policy against the device instance tree at step 710. If no match occurs, then the policy is not represented on a device and we abort to the next policy in the list (because the entire policy must match to be recognized) and return to step 705.

At step 715, if the first contained sub-component is matched at one or more places in the instance tree, we then look at two sub-cases. Some policies simply aggregate a set of components and data for use as a “package” or policy. In these cases, the order in which components are recognized in the tree does not matter. In other cases, however, order matters. Route maps or access control lists (both of which are represented as policies) aggregate together components, but do so in a particular order. Processing branches to step 720 for unordered policies, and to step 730 for ordered policies.

For an unordered policy, at step 720, the next sub-component in the instance tree is checked to see if it matches a component in the policy. If not, we abort to the next policy to be recognized, at step 705. When we find a match between the first sub-component of a policy and the device instance tree, it is sufficient to simply find matches for the remainder of the policy sub-components elsewhere in the instance tree within the sub-tree of the node which contained the first component match. The latter requirement prevents situations where trivial matches in widely disparate segments of the tree are misinterpreted as the presence of a policy on a device. As each component is matched to a policy, a check is made to determine if the policy is fully matched, at step 725. If it is, then processing advances to step 740, otherwise the next component in the instance tree is tested at step 720.

For an ordered policy, at step 730, the next sub-component in the instance tree is checked to see if it matches a component in the policy. If not, we abort to the next policy to be recognized, at step 705. Once we match the first sub-component within the instance tree, we then walk the remainder of the sub-components in order to determine if they match the instance tree in the correct order. Only if all components contained within a policy match components found in the instance tree, in the correct order, is the policy called a “match.” As each component is matched to a policy, a check is made to determine if the policy is fully matched, at step 735. If it is, then processing advances to step 740, otherwise the next component in the instance tree is tested at step 720.

Assuming that a policy is matched in the instance tree, we then replace the original components within the instance tree with the policy itself, at step 740. This is done by finding the site in the instance tree at which the first sub-component of the policy matched the instance tree, and replacing that component with the policy itself. All other sub-components which matched are then simply deleted from the instance tree in order to prevent duplication.

This process is repeated for all policies in the policy database. The end result of this analysis is an instance tree which contains any policies which the device implements, any components which are identified within the device configuration but are not part of a policy, and any candidate components which are recognized for the first time. Such an instance tree is considered “complete” and is the output of the Device Learning System 44, and is ready to be stored persistently to the component database 28 and within a version control database.

Once post-processing is complete, the instance tree for a device configuration is complete, and can be persistently stored to versioned storage within the system. At this point, the configuration represents a PD configuration 16.

In an embodiment, the instance tree is persisted to an XML data format, and stored as a file in a version control database. Once stored in version control, we can reconstruct the change history of the configuration between any two editing sessions (so long as an editing session is saved and not abandoned or purged).

In the text above, we described the overall method of an embodiment, for parsing the native configuration and recognizing instances 20 of library components 26. We also described the fact that parse errors indicate that the parser has encountered configuration syntax that is not contained within any recognized component 54. Thus, the syntax errors themselves represent a significant source of information about potentially new components. The method for handling parse errors is described in detail below.

Under normal usage, a conventional parser stops parsing when a syntax error is encountered, and reports the error and the offending syntax to the caller. This approach is typically seen within compilers, for example. Thus, the location of the error is known.

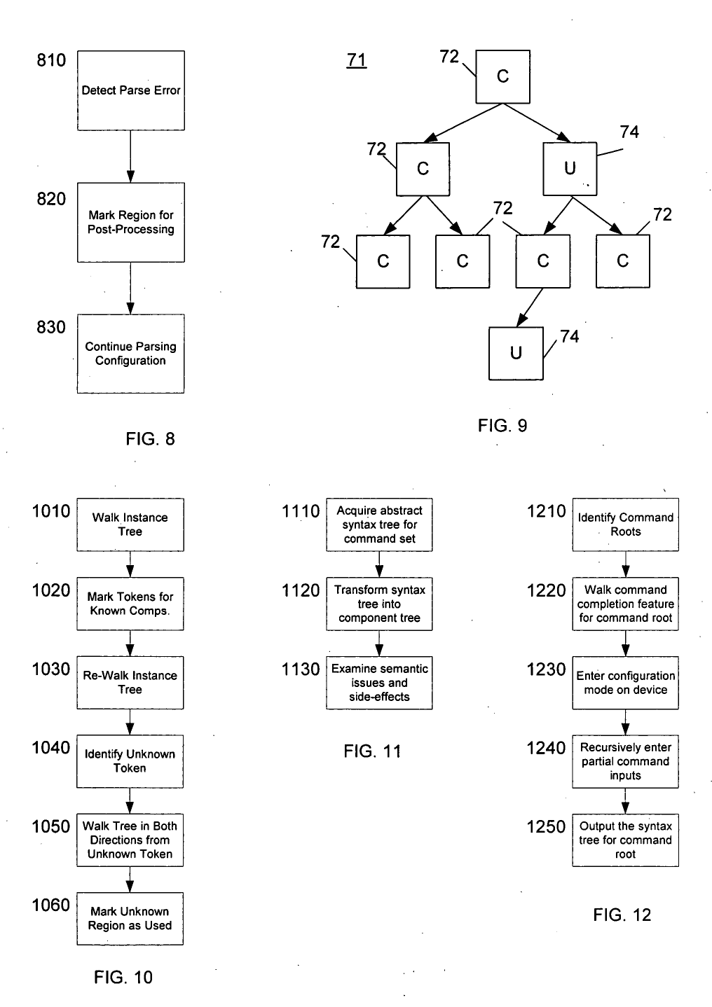

Within the parsing step 640 performed by the Device Learning System 44, parse errors are processed according to the method of FIG. 8. Parse errors are trapped and marked for later post-processing at step 810. Instead of adding a normal component instance to the output tree, an “unknown” region marker is added to mark the spot, at step 820. Parsing then continues at step 830 until the next error occurs or the end of the input configuration 50 is reached. The resulting output is therefore an instance tree 71, which is a tree-organized data structure, composed mostly of component instances 72 with data, and an occasional “unknown” region 74, which marks a place where un-parseable syntax occurred.

At this stage, however, the Device Learning System 44 does not know the extent or contents of the “unknown” region 74, since this syntax was un-parseable and no semantic actions were taken. Only the location is known. Resolution of “unknown” region markers into candidate components 58 is done by post-processing the instance tree 71 in combination with the token database built by the lexer 60.

TABLE 1
Example native syntax, tokenized with token ID's
(third line is “unknown” syntax)

interface¹ serial² 1/0³ \n⁴
ip⁵ address⁶ 192.168.1.1⁷ 255.255.255.252⁸ \n⁹
carrier-delay¹⁰ msec¹¹ 300¹² \n¹³
bandwidth¹⁴ 1534¹⁵ \n¹⁶

During the initial parsing run, as discussed above, the lexer 60 feeds tokens to the parser 62. The lexer 60 also builds a table of tokens with unique identifiers (IDs) which indicate the order in which tokens were found in the original input text (Table 1). The parser 62 records the unique ID for each token in the instance tree 71 with each token making up a matched rule (Table 2). Token IDs are used during post-processing to isolate and identify the contents of unknown syntax regions which become candidate components 58. When an “unknown” syntax region 74 is encountered through the parse error handler, it is marked with the token ID of the token where parsing failed to reduce a grammar rule (in the Table 1 example, this is token #10)

TABLE 2
Lexer token database

| ID | Token | UsedFlag |
|---|---|---|
| 1 | interface | |
| 2 | serial | |
| 3 | 1/0 | |
| 4 | \n | |
| 5 | ip | |
| 6 | address | |
| 7 | 192.168.1.1 | |
| 8 | 255.255.255.252 | |
| 9 | \n | |
| 10 | carrier-delay | |
| 11 | msec | |
| 12 | 300 | |
| 13 | \n | |
| 14 | bandwidth | |
| 15 | 1534 | |
| 16 | \n | |

Turning to FIG. 10, after initial parsing, during post-processing (step 670 of FIG. 6), the output instance tree 71 is walked in order to resolve the extent and contents of each unknown marker 74, at step 1010. Each instance object 72 in the tree contains a sequence of tokens which make up the syntax of the component instance. For each token referred to within an instance 72, at step 1020 we look up the token ID within the lexer's internal database and mark it as used (Table 3). Thus, at the conclusion of the instance tree traversal, each token making up the syntax of known components 54 is marked within the lexer database.

TABLE 3
Lexer token database, post-processed to mark tokens
used in recognized components

| ID | Token | UsedFlag |
|---|---|---|
| 1 | interface | x |
| 2 | serial | x |
| 3 | 1/0 | x |
| 4 | \n | x |
| 5 | ip | x |
| 6 | address | x |
| 7 | 192.168.1.1 | x |
| 8 | 255.255.255.252 | x |
| 9 | \n | x |
| 10 | carrier-delay | |
| 11 | msec | |
| 12 | 300 | |
| 13 | \n | |
| 14 | bandwidth | x |
| 15 | 1534 | x |
| 16 | \n | x |

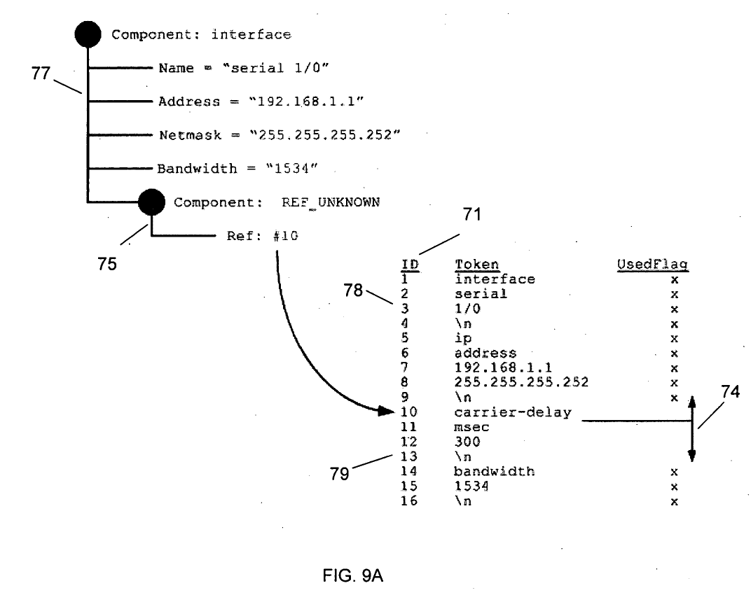

As a result, any tokens that remain unmarked within the lexer database are necessarily part of syntax regions which do not match anything in the component database 28. Furthermore, each unknown syntax region 74 is associated with some contextual information concerning association with other components (depending upon the nature of the vendor configuration language), because of the position of the unknown region in the parsed instance tree 71 (See FIG. 9A). For example, referring to FIG. 9A, the “unknown” sub-component 75 is known to be a sub-component of the known “interface” component 77, because the unknown region 74 is located in the parsed instance tree 71 between two known sub-components 78, 79 of the “interface” component

At step 1030, we walk the instance tree again, sequentially post-processing each “unknown” region marker 74. The token ID listed in each unknown marker 74 is followed into the lexer's token database at step 1040. This token ID only marks a spot within the lexer database—we still know nothing about the extent of the region. To resolve the extent and contents of the unknown region, we therefore walk the lexer token database in both directions from this starting point, until we encounter tokens that had been previously marked as “used” by existing instances at step 1050. The region between these boundaries is thus the contents of a new candidate component 58 which replaces the unknown marker 74 in the output instance tree (Table 4). Finally, at step 1060, the tokens which made up the unknown region 74 are then marked as “used” to prevent future passes through the lexer database from encountering the same unknown twice.

TABLE 4
Post-processed instance tree fragment,
with candidate component inserted in proper context

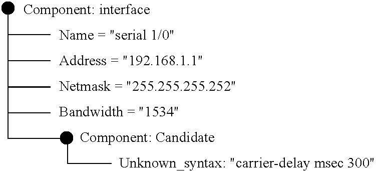

The resulting candidate component 58 is not yet stored within the component database 28, but it is a fully featured component instance and is persisted as part of the final device configuration. At this point, the candidate component 58 is private, occurring only within a single device configuration. It cannot be reused or referred to by name. This allows new syntax to be tried within the context of a single device 10 without side effects on the network as a whole. Candidate components 58 become available for reuse when or if Grammar Builder 45 converts the candidate components 58 to components 26.

The method used to resolve unknown regions 74 into candidate components 58 is “greedy” in the sense that adjacent unknown regions are collapsed into a single candidate. This effect occurs because we walk the lexer database in both directions from the initial token ID which serves as a pointer into the database. The first pass through a given unknown region 74 thus consumes all of the unmarked tokens found, associating them with the first candidate created in a given region. When further unknown markers in an adjacent set are post-processed, no unused tokens are found in the lexer database upon de-referencing their pointer ID's. To simplify the implementation, empty instances are created in such situations, which are compressed out of the final instance tree during the late stages of post-processing as discussed above.

Once the candidate components 58 have been identified using the methods discussed above, these candidate components 58 are then resolved into formal grammars 70 by the Grammar Builder 45 system. Automated grammar production is a three phase process as shown in FIG. 11. In the first phase at step 1110, a mechanism is used to acquire a syntax tree for a set of commands. As an example, within the command interface on Cisco IOS devices, the command interpreter provides “tab completion” and limited help or prompting for commands.

This facility is sufficient to discover the syntax of unknown commands. Any other method of acquiring these data is also acceptable, so long as the resulting information is accurate (for example, it is also possible to parse electronic documentation.)

In the second phase at step 1120, the syntax tree is transformed into a usable component tree according to a set of algorithms which is partially vendor-neutral, but also including specific transformations appropriate to a specific command language. In the third and final phase at step 1130, vendor-specific mechanisms are used to examine semantic, rather than syntactic, issues with how commands are added and removed from a device, and any “side-effects” they may have within the configuration. Semantic information about component interaction is added to the grammar in the form of “tags” which can be used by other applications in addition to the Device Learning System 44. The resulting grammar is then “complete” apart from any adjustments that are made to the quality of labels (since automatically generated labels are often fairly difficult for human users to comprehend).

Turning to FIG. 12, acquisition of an abstract syntax tree (Phase I) begins with. identifying a set of “command roots”—e.g. the first several tokens that make up a command in a line-oriented configuration language. Roots serve to define the starting point and “breadth” of a syntax tree search. As an example, we will use the command “ip route 10.0.0.0 255.0.0.0 192.168.1.100 10”, which adds a static route to the IP network 10.0.0.0 via the network link located at 192.168.1.100, with a “distance” (or preference, essentially) of 10. The “command root” we will start with is the partial command “ip route,” and our goal will be to automatically discover the syntax of “ip route” commands in IOS 12.2. Starting points are arbitrary—we could equally begin, for example, with the command root “ip” and discover all commands that follow this root. When Grammar Builder 45 is activated within the system, the “command root” will be provided by the candidate component 58 being resolved into a resolved grammar 70.

In order to discover the allowable syntax, at step 1210 an embodiment of the invention uses a vendor-specific algorithm to “walk” any command completion or command-line help available, and view the options available at each point in the command structure. This algorithm is generically called “WalkerViewer.” In an embodiment disclosed below, the WalkerViewer algorithm for Cisco's IOS operating system is discussed in detail. Other operating systems and other vendors are also supported by modified version of the WalkerViewer algorithm. For example, the WalkerViewer algorithm for Cisco's Catalyst operating system differs only in minor details.

The WalkerViewer algorithm for Cisco IOS begins at step 1230 by entering “configuration mode” on a network device (often a device in a test or lab network setting). Within configuration mode, the operating system provides “command line completion” of partial commands. When an incomplete command is entered, possible “next completions” are available by pressing “?” at the end of the partial command fragment. By adding each possible completion to the current command root recursively, all of the possible command options available below a starting root are discovered, at step 1240. Termination occurs in a given “branch” whenever we encounter a carriage-return <cr> or “end of line” (EOL) character.

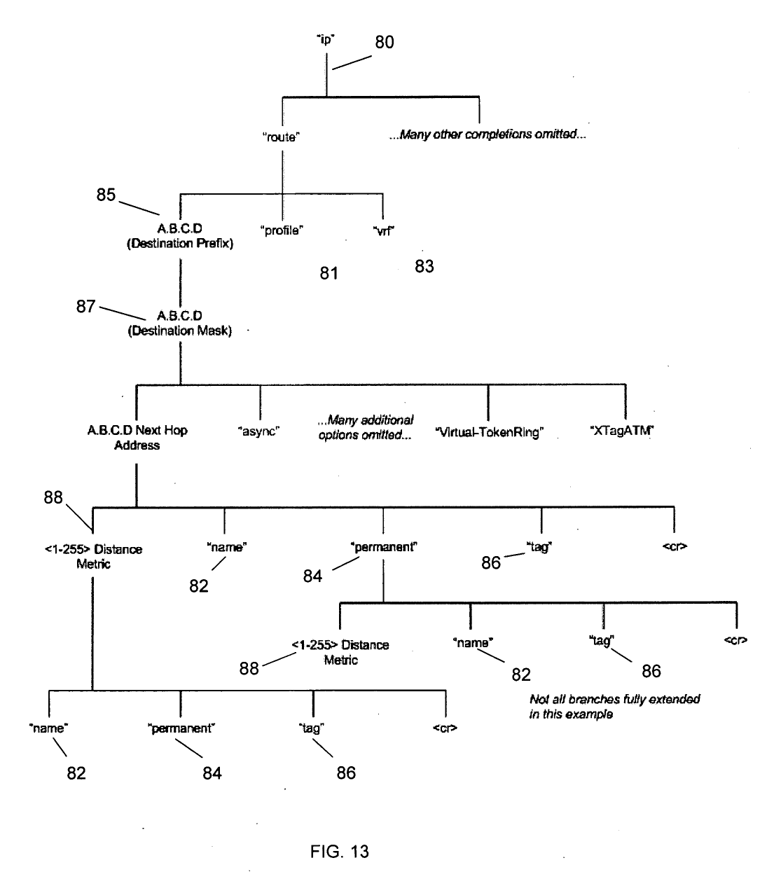

A partial example of the syntax tree 80 obtained by running WalkerViewer against the command root “ip route” is shown in FIG. 13. For example, when WalkerViewer tests the command root “ip route” on a network device running IOS 12.2, the following options are presented as appropriate in the next position within the command syntax: “profile” 81, “vrf” 83, and “A.B.C.D” 85. The first two are command tokens which trigger further options (and are irrelevant for this example). The third is a placeholder for an IP address variable—in this case, the destination prefix (as explained in the accompanying text).

Following the destination prefix further into the tree, we then add a proxy value for “A.B.C.D” to the end of “ip route” to form our next command root, and query for possible completions. This action results in a single response: “A.B.C.D destination netmask” 87. This is added to the partial command string, filling in “proxy” values for any variables, and the process is repeated.

At each stage in the recursive process, the set of options are added to a syntax tree as a series of SyntaxNodes. Each token or variable which can follow a partial command is entered as a child of the preceding token. Each SyntaxNode records the specific token, its data type (e.g., IP address, word, integer), and other specific metadata about the node. The example shown in FIG. 13 shows the tree as if we follow the example command given above: “ip route 10.0.0.0 255.0.0.0 192.168.1.100 10” with a carriage-return (<cr>) terminating the command. The full tree, depicting every possible continuation at each child location, is many times larger.

As mentioned above, WalkerViewer will proceed down the syntax tree 80 obtained by command completion until every attempt to delve deeper is terminated by an end-of-line character. In some cases, however, commands can admit options in any number of locations within a single line of syntax, which creates repeating “loops” of options as you query command completion. The “ip route” example displays a simple example of this looping behavior. The options “name” 82, “permanent” 84, “tag” 86, and the distance metric 88 can occur in any order, which causes each to present the others as possible completions (i.e. as children of each other on the syntax tree 80).

WalkerViewer handles situation-specific processing of such occurrences, for example by accepting a plug-in designed to handle specialized processing needs such as loop processing. One plug-in recognizes the situation noted in the previous paragraph: a set of options which can occur in any order and may or may not be present. In such cases, the plug-in marks the parent in the tree as possessing “children which are allowed to contain loops.” This metadata is used below to correctly post-process loops within the syntax tree 80.

At step 1250, the output from WalkerViewer is “raw data” for all subsequent steps in processing, and may be a very large and poorly structured tree, from the perspective of human comprehension. It contains a combinatorial set of all the options available for a given command root in all of the orders possible. Additionally, with the entire syntax tree 80 it isn't immediately obvious where human-perceivable “commands” begin and end. Thus it is helpful to post-process the tree into a well-structured grammar.

In the second phase (Phase II), the raw syntax tree 80 is post-processed into a grammar which includes structure recognizable to a human network engineer. In the following text, we first introduce the details of grammar construction within an embodiment of the invention, and then cover the four steps involved in post-processing SyntaxNodes into a finished grammar according to an embodiment of the invention.

In addition to the purely technical requirement that we generate grammars which are capable of parsing each vendor's commands, an embodiment of the invention also uses the grammar as the basis for constructing many user interface elements. Thus, in an embodiment, we generate formal grammars which are not only correct but structured in a human-understandable manner. Since grammars help auto-generate user interfaces 40 such as configuration editors or tree-based views of a device configuration, the grammars of an embodiment of the invention have the following conditions:

Grammars should be as small as possible, consistent with the need for correctness. Small grammar size is helpful not only for user comprehension, but overall application performance.

Grammars should be as “shallow” as possible. In other words, if the syntax of commands is represented as a tree, the user should only have to “drill down” the minimum number of levels possible to discover an option or command they are seeking.

Grammars should reuse as many common constructs as possible. We should avoid duplication whenever possible.

The algorithms take a tree of SyntaxNodes as output from WalkerViewer, and produce a mathematically correct grammar, and then post-process this grammar into a form which attempts to meet these conditions.

The grammars used in an embodiment of the invention are composed of the following constructs:

LITERAL—a token that appears verbatim in the command being matched. Groups of literals are the key to disambiguating the different “commands” within a vendor's configuration language.

ATTRIBUTE—a token that can have a range of values, often constrained by “type” but supplied as data by the user. Types are defined by the language itself and the grammar author. Examples include types such as integers, IP address, word, phrase with embedded white-space, and so on.

LIST—an ordered set of any of the grammar constructs. in the current list. A list such as “A B” has the grammatical meaning of “an object of type A followed by an object of type B.”

OR-BLOCK—an unordered set of any of the grammar constructs in the current list. An or-block such as “A|B” has the grammatical meaning of “a token of type A or a token of type B may occur in this position.”

SECTION—a named grouping of grammar constructs. Sections are a “convenience” in a pure sense, simply allowing grammars to “reuse” groups of elements by reference. This keeps the size of the grammar rule-base small, which is a concern when creating program code to implement the parser.

Certain kinds of sections are also used to mark the boundaries of human-understandable concepts. For example, the final grammar for all of the commands in Cisco's IOS is one giant tree. In order to mark segments of the tree which represent the rules for what users would recognize as components, or individual IOS commands, we mark certain sections as “FINAL.” In a similar way, we also mark some sections as “CONTAINER” sections, to organize the tree of commands into a hierarchy which mirrors common networking concepts, instead of presenting a flat, unorganized set of commands. These markers are not true parts of the grammar from a parsing perspective, but instead are grammatical metadata used by an embodiment to construct the user interface.

In a similar way, certain positions in a command may admit to a constrained set of literals or attributes. These positions can be marked as an ENUMERATION, which really are an OR-BLOCK of allowable LITERALS or ATTRIBUTES permitted in a given position. Again, enumerations are not necessary for parsing or compiling, but instead represent a grammatical optimization used in constructing a user interface which is intuitive and comprehensible without knowledge of system internals.

As a further simplification, attributes or literals which can take only two values (“on” or “off”) are transformed into BOOLEAN constructs. These do not affect parsing at all, but instead are used as an optimization in constructing the user interface.

The second phase in grammar production takes the raw tree of SyntaxNodes developed by WalkerViewer, and produce a set of grammar rules. In our simple example, the end result is going to be a well-structured grammar which can parse commands beginning with “ip route” and containing numerous IP addresses and other data values.

The result of processing of the syntax tree 80 is shown in Table 6 below. In contrast to the syntax tree 80, note that there is only one “path” through the grammar rule, as defined by end-of-line characters. Multiple possible paths through the tree of SyntaxNodes have been collapsed into alternate or optional sections. The top-level rule is marked as “FINAL,” denoting a grammar section which corresponds to a single user-perceptible command—in this case, our “ip route . . . ” example.

In the text below we discuss the algorithms for post-processing the syntax tree 80 into Table 5 below.

TABLE 5
Post-processed component reflecting the
“ip route” command with options.

```
CiscoIOSStaticRoute: FINAL.
  “ip” “route”
  ATTRIBUTE(ipaddress, “prefix”)
  ATTRIBUTE(forward_mask, “netmask”)
  CiscoIOSStaticRouteDestination
  [ CiscoIOSStaticRoute_Distance ]
  [ CiscoIOSStaticRoute_Tag ]
  [ CiscoIOSStaticRoute_Permanent ]
  [ CiscoIOSStaticRoute_Name ]
  EOL;
CiscoIOSStaticRouteDestination:
  Destination_Hop|Destination_Interface;
Destination_Hop:
  ATTRIBUTE(ipaddress, “Gateway”);
Destination_Interface:
  ATTRIBUTE(word, “Interface Name”);
CiscoIOSStaticRoute_Distance:
  ATTRIBUTE(integer, “Distance Metric”);
CiscoIOSStaticRoute_Tag:
  ATTRIBUTE(word, “Tag”);
CiscoIOSStaticRoute_Name:
  ATTRIBUTE(word, “Name”);
CiscoIOSStaticRoute_Permanent:
  BOOLEAN(“Permanent”, “permanent”, “”);
```

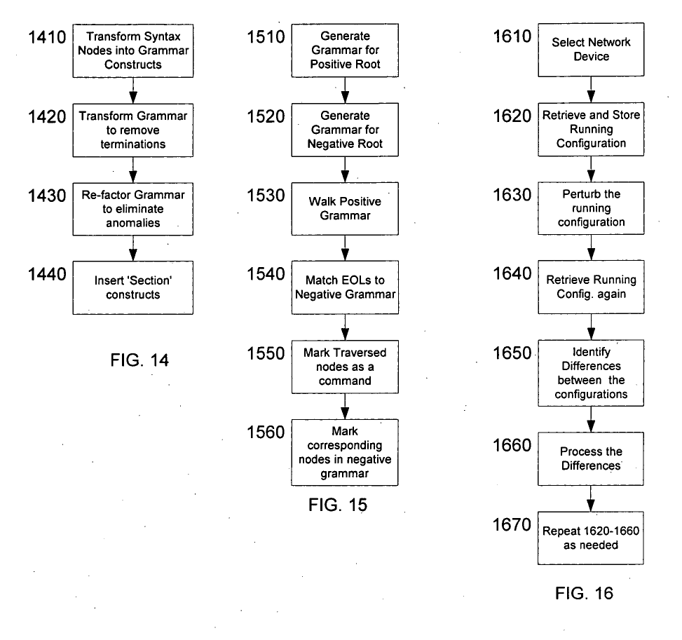

Turning to FIG. 14, the first step 1410 is to simply transform SyntaxNodes into their equivalent grammar constructs through equivalences between SyntaxNode types and grammar constructs. Some of the translation rules used include:
SyntaxNode literal→grammar LITERAL
SyntaxNode data value (any type)→grammar ATTRIBUTE of the corresponding type
SyntaxNode terminal→grammar EOL (a special token denoting a vendor-specific end-of-line character)

Each level in the tree of SyntaxNodes is a set of “siblings,” which are translated into an OR-BLOCK.

Ancestor/descendant lines through levels in the syntax tree form a LIST.

Transform any nodes marked as “children allowed to loop” in the previous phase into grammar sections which are allowed multiple times (“multiply allowed”).

The output grammar has no sections, has repeated literals and elements in many places, and many EOL terminations, but is technically capable of parsing device input. The results will not mean much to a human observer, but the grammar is mathematically correct.

At step 1420, the resulting grammar is transformed to remove unnecessary EOL terminations, and guarantee that each command follows a single path to a single EOL termination. Multiple terminations occur because most commands have sets of options which can be used in different combinations to form a valid command.

As an example, consider our simple “ip route” command above. The “tag” 86, “name” 82, “permanent” 84 and distance metrics 88 can be used alone, or in any combination (and in any order). Thus, the grammar generated by transforming the syntax tree 80 contains multiple paths—one for each ordering and combination of options. We restructure the grammar to “compact” it and produce a simple, clean structure. This is done by examining parts of the grammar where OR-BLOCKs and LISTs contain common elements and re-arranging them into a new set of lists and or-blocks which lead to a single terminal EOL marker.

Because the grammar for a command root is automatically generated, it may have a number of structural anomalies which don't affect parsing but are strange to the human user. At step 1430 of this phase, the grammar is restructured to eliminate common anomalies. Below is a list of the some example restructurings. Additionally, each new vendor has the potential to expand the list of desired restructuring transformations. The plug-in architecture of an embodiment of the invention makes it easy to expand the list of restructuring transformations to handle changes in vendor-specific situations.

Common endings that are repeated in OR-BLOCKs are “factored” out. For example, if the grammar contains the following:
a xy|b xy|c xy
   where a,b,c,x,y are literals or other grammar constructs, we refactor the grammar as follows:
(a|b|c) xy

Another common transformation is to find common sub-expressions in nested portions of the grammar, and “flatten” them into a single list. For example, if the grammar contains the following:
(a|b|c|d(a|b|c))
   Where a,b,c,d are literals or other grammar constructs, we refactor the grammar as follows:
(a|b|c|d) . . .

In this refactoring, the “. . . ” designation indicates a grammar construct which is allowed to occur multiple times. These representations are not precisely equivalent mathematically, but for practical purposes the resulting grammar correctly parses configuration text and is far more understandable to users.

Automatic generation may also leave optional elements “orphaned” within an OR-BLOCK. These elements can be “flattened” into a simpler OR-BLOCK:
[a]|[b]|[c] is refactored into a|b|c

Finally, we make a full combinatorial search of the grammar to find segments which are repeated. These segments are put into sections (as defined above), and their occurrence replaced by reference to the new section. This drastically reduces the overall size of the grammar by removing redundancy, at some cost to complexity.

After the previous step, the grammar is now well structured and nearly ready for use. The grammar, however, is a single tree, with no “boundaries” which denote where commands begin and end. This is mathematically unnecessary for parsing, but crucial for presenting the results of parsing to the human user. Thus, in the final step of Phase II, at step 1440, we insert “section” constructs within the grammar with FINAL markers wherever command boundaries occur. Each command, complete with its suite of options and attributes, is therefore turned into a component 26. These components 26 are then able to be stored in the component database 28, as fully-functional and shareable components, and can be reused in policies 34 as desired.

The algorithms for marking command boundaries may differ between vendors and command languages, necessitating a modular architecture (as with other steps in the Device Learning System). In this section, the algorithm for Cisco's IOS and CatalystOS command languages is described by way of example. This algorithm will also work for any command language which has a rigorous form of command negation and command completion on the command line. Other embodiments for other vendors and command languages are also possible.

Network device command languages typically have “positive” and “negative” forms for each piece of functionality. “Positive” command forms typically activate a piece of functionality, whereas “negative” command forms de-activate or “remove” a piece of functionality from the running network device. This feature helps provide one way of locating command boundaries, according to an embodiment of the invention. Thus, by comparing the grammars generated for both positive and negative forms of commands, we can locate the nodes within the grammar which represent the start of a command. This relies upon the fact that the two trees will differ only by the syntax required in a given command language for negation. For example, in Cisco IOS and other command languages, commands are usually removed by pre-pending “no” to the beginning of the command.

With reference to FIG. 15, at step 1510 we begin with the positive grammar created using the methods discussed above. Using the methods discussed above, we also create a negative grammar by generating a WalkerViewer syntax tree using the same command root with “no” prepended, at step 1520. The remaining stages of grammar production are identical. The result is two grammars—one which applies functionality (“positive”) and one which removes functionality (“negative”).

Thus, to find and mark all of the “command boundaries” within the grammar, we walk through the “positive” grammar node by node, at step 1530. At each node, we look at the “negative” grammar to determine if a terminal end-of-line character is in an equivalent position as in the “positive” side, at step 1540. If it is, we have found the boundary of a “command” and can mark the area of the tree traversed as a FINAL section (the grammar equivalent to a component), at step 1550.

The final step is to merge information from the “negative” grammar tree into the positive tree, in order to create a single grammar which has the ability to generate both activation and de-activation (positive/negative) forms of each command. This is done by transplanting the negative form of the command into a sub-section of each FINAL section, marking the negative form as a REMOVAL, at step 1560. This tag allows the compiler to generate either a positive or negative form of a command, depending upon whether the user's action was to add a component to a network device, or remove it.

Up to this point, the grammars produced operate under the assumption that components 26 are “orthogonal” to each other—in other words, that each can be applied and removed without affecting any other portion of the configuration 50. Sadly, on many platforms, this assumption is unwarranted. The addition or removal of a command from a device configuration 50 will often trigger various “non-local” changes in other aspects of the configuration. In order to fully understand the effect that addition and removal has upon a network device 10, the system catalogs these effects during grammar production. In the sections that follow, these effects are referred to generally as the command-level “semantics” of commands (and by extension, components 26).

One example of a command-level semantic effect is the necessity of understanding removal of a component 26. Removal semantics are actually recorded in an earlier step in grammar production because we also “sectionize” the grammar into components 26 at the same time. Command-level semantics can vary by platform, but some common effects seen on network devices today include:
Commands may have “default” values for some attributes. On some platforms, when the command is issued with default values, it does not appear in the running configuration of the device. When the attributes are changed to non-default values, the command then “appears” in the configuration. This is largely a cosmetic issue rather than a real difference in device functionality, but from the perspective of configuration management, it is a significant semantic effect.
Command attributes may have multiple equivalent formats. For example, port numbers in Cisco IOS frequently have textual equivalents (e.g., port 80 can also be entered as “www”). This is also a cosmetic issue from the perspective of device functionality, but from the perspective of configuration management, it too is a significant semantic effect, and it is desirable to be able to handle a device that silently transforms one format to another.
Commands vary in their “duplication” behavior. In other words, some commands must be absolutely unique, whereas other commands may be allowed multiple times in a configuration with different values for key attributes. Given the command syntax alone, we cannot know this, but in order to guarantee proper configuration behavior, this is important information to discover during grammar production.
Commands are often “tied” together in non-obvious ways. Adding one command may cause others to appear in the configuration (often at their default value), whereas removing a command may cause other commands to disappear from the configuration.

These are examples of command semantics that appear on a number of platforms across the Cisco product line. Platforms from other vendors, for example, include other forms of semantic effects. Fortunately, the plug-in nature of an embodiment of the invention allows us to expand the set of algorithms for semantic discovery in a seamless and natural way.

Examples of the semantic effects we catalog are as follows:
Different representations for the same data value (port 80=“www”).
Default values for attributes which cause the command to disappear from the native configuration when entered.
Dependencies between components upon addition/removal.
Parameters which make components unique amongst other instances of the same component.
The set of parameters which are important in determining whether a component was properly added or removed from a device during download testing

Each method for command-level semantic discovery is based on the general method of FIG. 16, with specific details for each type of semantics to be discovered:

The method begins at step 1610, by selecting a network device with the appropriate operating system and version characteristics. At step 1620, the running configuration of the device is retrieved. At step 1630, the configuration is perturbed according to the type of semantic data we're gathering. At step 1640, the running configuration is retrieved again. At step 1650, the differences between the “pre” and “post” change configurations are determined. At step 1660, the differences are processed according to the specific type of semantics being investigated. At step 1670, the prior steps are repeated, with various combinations tried in order to discover the data needed.

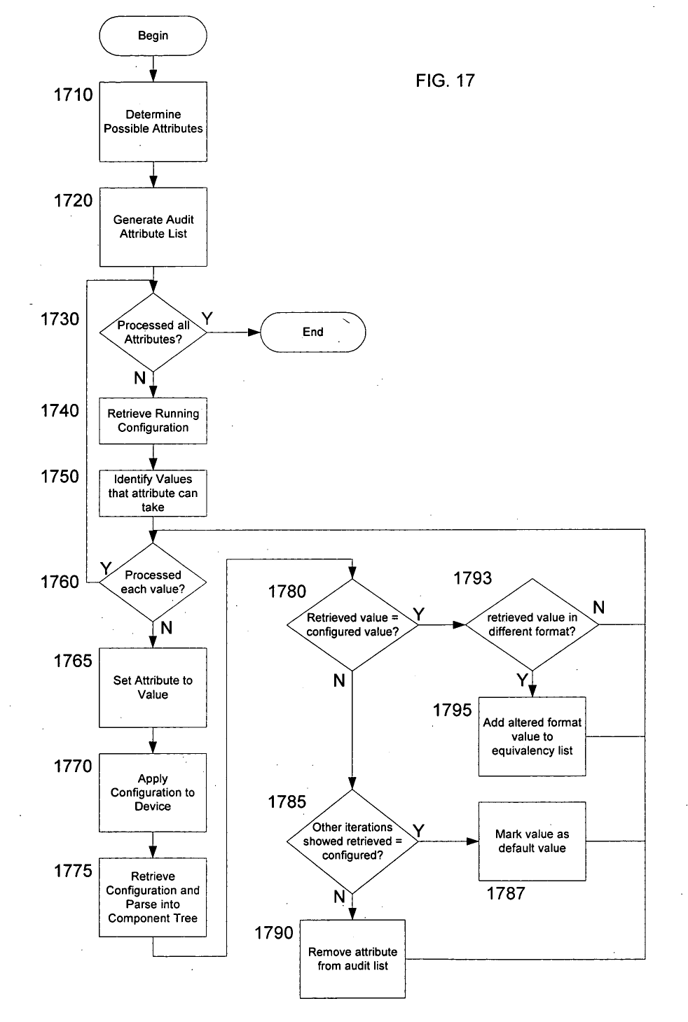

Turning to FIG. 17, discovering default values and equivalencies, and otherwise auditing configuration behavior is a combinatorial process. Starting with a component (abbreviated as “C” in the algorithm below), and a suitable test device, the method proceeds:
1. Determine the list of possible attributes for component C. This list will be denoted as POSSIBLE_ATTR. (step 1710)
2. Start with a copy of POSSIBLE_ATTR that denotes the list of attributes which are useful to determining the success of a download onto a network device. This list is called the “audit attributes” list, and is scrutinized upon download to determine whether a component shows up properly after download. This list will be denoted AUDIT_ATTR. (step 1720)
3. For each attribute (ATTR) in POSSIBLE_ATTR, do the following (step 1730):
   a. Retrieve the configuration of the network device.(step 1740)
   b. Determine the list of possible values that ATTR can take. (step 1750) If the attribute is of a type with a short “known” list of values, test each of them. If the attribute is of a type with a large (or infinite) list of values, apply a sampling strategy to test a list of statistically representative values. This list of possible values will be denoted as ATTR_VALUES. In some cases, it may be necessary to exhaustively test a range of attribute values in order to find the default values. As an alternative, default values can be supplied by a human user or “discovered” by parsing the vendor's documentation if available in machine-readable format. Also, it may be possible on some platforms to query for default values using the command-line interface: Cisco's Catalyst OS platform allows this, which would obviate the need for exhaustive search, although the procedure is still needed to discover auditing/post-download behavior and attribute equivalencies.
   c. For each value (VAL) in ATTR_VALUES, do the following (step 1760):
      i. Set the value of ATTR in component C of the configuration to VAL. (step 1765)
      ii. Apply the configuration to the device. (step 1770)
      iii. Retrieve the new running configuration of the device, and parse this configuration into a component tree. (step 1775)
      iv. If ATTR shows up in component C as VAL, move onto the next value (since this is not the “default” value for VAL). (step 1780)
      v. If ATTR doesn't show up in component C as VAL, but other values of ATTR (from prior or subsequent iterations of the algorithm) do show up as their corresponding values (step 1785), then VAL is the “default” value, and is marked as such in the grammar for component C (step 1787).
      vi. If ATTR doesn't show up as VAL, and no other values do either, remove ATTR from the list of AUDIT_ATTR, since it cannot be reliably tested as part of the post-download test comparison. (step 1790)
      vii. If ATTR shows up, but in a different format (or even data type) (step 1793), add it to a list of “equivalency” mappings for the component. For example, port numbers will often be assigned as numbers (e.g., 80), but will be returned or displayed in textual equivalents (e.g., WWW). (step 1795)

The information gathered in the method of FIG. 17 is principally used within regular configuration audits and post-download configuration comparisons to ensure accurate tracking of errors. In other words, “disappearing defaults” or automatic translation of values which have equivalency mappings should not be reported as errors.

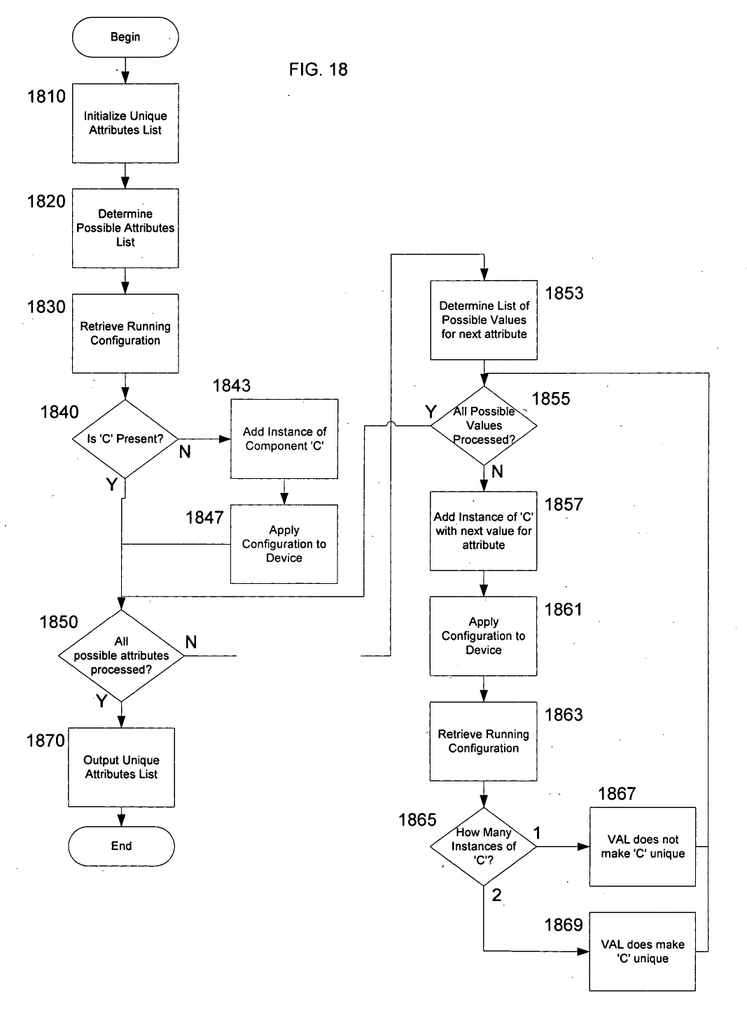

Turning to FIG. 18, discovering which attributes require unique values in order to create a unique “instance” of a component (and thereby, a unique command) is a combinatorial process. We start with a component 26, and determine what combinations of its attributes' values can co-occur on a device 10. The result of this may be that (a) the component 26 is only allowed once on a device 10, or (b) some combination of values of some attributes defines a “unique” instance of the component 26, where multiple unique instances can exist on a device 10. If we begin with a component (abbreviated as “C” in the algorithm below), the process of determining uniqueness is as follows:
1. Start with an empty list, to which we will append the names of attributes that denote a unique instance of component C. This list will be denoted as UNIQUE_ATTR. (step 1810)
2. Determine the complete list of possible attributes available for component C. This list will be denoted as POSSIBLE_ATTR. (step 1820)
3. Retrieve the running configuration of a test device. (step 1830)
4. Determine if the configuration already has an instance of component C present. (step 1840) If not:
   a. Add an instance of component C, with randomly chosen attribute values (of appropriate types), to the device configuration. (step 1843)
   b. Apply the configuration to the device. (step 1847)
5. For each attribute (ATTR) in POSSIBLE_ATTR, do the following (step 1850):
   a. Determine the list of possible values for ATTR. (step 1853) If the attribute is a type with a short “known” list of values, test each of them. If the attribute is a type with a large (or infinite) list of values, generate a sample of possible values that is statistically representative. If the attribute is a type with a constrained range of values (discovered by WalkerViewer during Phase I), select a sample of values from within this range. This list of possible values will be denoted as ATTR_VALUES.
   b. For each value (VAL) in ATTR_VALUES, do the following (step 1855):
      i. Add a second instance of component C to the device configuration, with VAL for the value of ATTR and otherwise identical to the existing instance of component C. (step 1857)
      ii. Apply the configuration to the device. (step 1861)
      iii. Retrieve the new running configuration of the device. (step 1863)
      iv. Determine how many instances of component C exist in the new configuration (step 1865):
         1. If only one instance of component C exists, we know that VAL is not one of the values (if any) for ATTR that makes an instance of the component C unique. (step 1867)
         2. If there are two instances of component C present, we know that VAL is one of the values for ATTR that makes an instance of component C a unique instance. Add ATTR(VAL) to UNIQUE_ATTR.
6. At the end of this combinatorial search, UNIQUE_ATTR will contain a list of the attributes and values for those attributes which cause an instance of component C to be unique. This list is added to the grammar as an annotation to component C. If UNIQUE_ATTR is empty when the method finishes, this means that only one instance of the component can be applied to a device at any one time. Add a notation to UNIQUE₁₃ ATTR that records that component C can only occur once in a configuration. (step 1870)

The information gathered on component duplication can be used a number of ways in an embodiment of the invention. For example, a user could be prevented from adding two instances of a component which can only occur once—instead, the existing instance could be replaced by a new instance.

In an embodiment, duplication information may be used in a number of ways to ensure a “consistent” and correct final configuration for each network device:
1. Every time a policy-driven configuration is compiled into a “native” configuration, the list of components is traversed and any duplicated components are evaluated according to their UNIQUE_ATTR list. Duplicates are disallowed if the component must be singly present, and if multiple instances are allowed, each instance is checked for uniqueness.
2. Whenever a component is inserted into a policy-driven (PD) configuration, the component is checked to determine if it must be singly present. Since data may not have been filled in for attributes at this point, we cannot yet check for uniqueness of multiple copies of the same component (this is checked at editing or compilation time).
3. Whenever a policy is inserted into a PD configuration, the list of components contained within the policy is checked against the policy-driven configuration. Any components which are duplicated between the policy and the PD configuration are evaluated. Components which must be singly present are deleted from the PD configuration and the instance from the policy is kept. Components which may be multiply present are evaluated according to their UNIQUE_ATTR lists. If there are still “overlaps,” given the uniqueness criteria, the version from the PD configuration is deleted and the version from the policy is kept. Retaining the policy version and deleting the PD configuration version is an implementation-dependent decision, designed to place as much reliance on policies as possible (in order to give customers the leverage of keeping configurations factored into policies). In alternate embodiments, the components from the PD configurations could be retained and those from the policies deleted, or other schemes could be implemented as desired.
4. Whenever the policy-driven configuration is edited, any change to an attribute value is examined to determine if it results in a duplicated component. If an edit does result in a duplicate component, the duplicates are evaluated according to their UNIQUE_ATTR lists, and if necessary, an error message can be presented to the user.

Discovery of dependencies between components is also a combinatorial process. We begin with a component, and determine the effect of adding and removing that component (with realistic test attribute data) from a device configuration. The linkages discovered are then added to grammar as annotations linking two components.

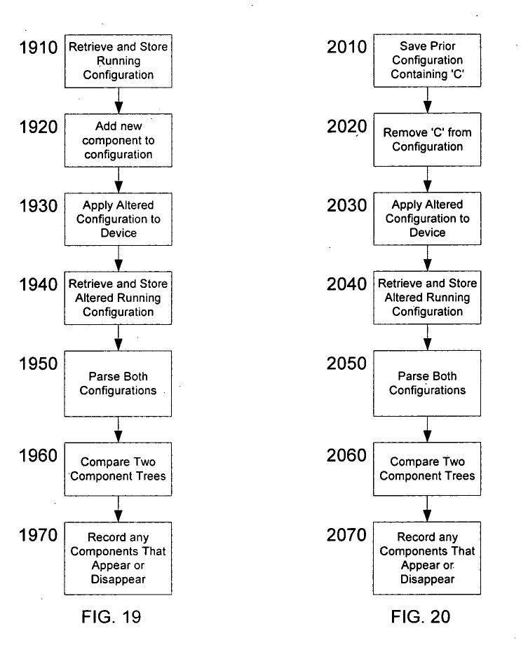

We begin with a component C, to discover its dependencies (if any):
1. Turning to FIG. 19, to determine dependencies upon addition:
   a. Retrieve the configuration of a test device, caching it for future use as PRE-CONFIG. (step 1910)
   b. Add a new component C to the configuration, filling in random values for required attributes (of the appropriate data types). (step 1920)
   c. Apply the altered configuration to the device. (step 1930)
   d. Retrieve the new running configuration, caching it as POST-CONFIG. (step 1940)
   e. Parse both cached configurations into a tree of components (step 1950), and compare the two trees, producing a list of differences. (step 1960)
   f. The list of differences between PRE-CONFIG and POST-CONFIG should include component C. Search for, and record, any other components which newly appear in the configuration as a result of adding Component C. Also, there may be components which “disappear” with the addition of component C. Add both to the list of “addition” dependencies for component C. (step 1970)
2. Turning to FIG. 20, to determine dependencies upon removal:
   a. Start with the POST-CONFIG, which contains component C. Cache this as the PRE-CONFIG for removal testing. (step 2010)
   b. Remove component C from the PRE-CONFIG. (step 2020)
   c. Apply this altered configuration to the device. (step 2030)
   d. Retrieve the new running configuration from the device, caching it as the new POST-CONFIG. (step 2040)
   e. Parse both cached configurations into a tree of components (step 2050), and compare the two trees, producing a list of differences. (step 2060)
   f. The list of differences between PRE-CONFIG and POST-CONFIG should include component C as a deletion. If no other differences are detected, then removal can be marked as free of dependencies. If not, the list of differences except component C itself constitute the removal dependencies of component C. Add any differences to the list of “removal” dependencies for component C. (step 2070)

The algorithm discovers removal dependencies that exist within a vendor language. The algorithm will discover all newly appearing dependent components in addition or removal dependencies, by definition, but it cannot discover a removed dependent component in either an addition or removal dependency unless the dependent component was present in the initial tested configuration. This can be remedied by, for example, exhaustive combinatorial testing of components in an N×N matrix. Also, performing addition dependency checking first, before performing removal checking, raises the likelihood significantly of seeing an accurate picture of removed components.

The data on inter-component dependencies is encoded Within the grammar as annotations on components 26. This data can be used in a number of ways within an embodiment of the invention. The dependencies can be used within the user's editing interface. When a component is added to a policy-driven configuration, dependent components can be added as well. Similarly, upon removal, dependent components can be removed if appropriate. The dependencies can simply be taken into account during post-download testing of a configuration. For example, if we download a new native configuration which removes component A from the device, we should expect the post-download running configuration to be missing component A and any components which have a removal dependency upon A. Similarly, if we add component B to the device, we should expect the new running configuration to contain component B and any components (with attendant data) which have an addition dependency upon B. These can be used in tandem, or separately, within an embodiment of the invention.

The system of an embodiment also allows for version control of all editable data in the system. In our preferred embodiment, PDC 16, policies 34, device data storage 22, instances 20, and components 26 are version controlled within the system. In other words, the component database 28 and other data storage entities in an embodiment can be constructed so as to preserve the history of changes to each of the stored data items. Example embodiments might use files stored in a commonly available version control system (e.g., RCS, Microsoft Source Safe); alternatives also include storing objects in a SQL database with tables tracking changes to each object. Version control, however accomplished, allows detailed tracking of when and by whom each data element is changed, and reconstruction of exact content and structural changes to each entity.

When a component or policy changes within the version-control database, the change implies that a number of devices (from zero to all of the devices in the inventory) may be affected and require new configuration download. The system tracks dependencies between device configurations and components/policies, such that changes can quickly be mapped to the set of devices requiring update.

Users won't often have to directly edit the grammars which underlie components, but in those situations where necessary, the system provides for an editing interface. The driving principle for syntax editing is that users should not be exposed to formal grammar specifications such as BNF or ASN.1. Operating directly upon grammar specifications is not only unfamiliar to most network engineers, but a highly error-prone process with broad ramifications throughout the system.

Therefore, an embodiment of the invention provides a mechanism for rendering a component 26 into a human-readable form which can be edited in a component editor 41. The component is compiled by the DLS 44 into its native result, by filling in arbitrarily chosen data values for any attributes. The result can be provided to the user in an editor 41, at which point any changes can be presented to the DLS 44 and Grammar Builder 45 for translation back into formal grammar 70 and modification of the component 26. The changed component 26 is then saved to the component database 28 for future use.

The changes are immediately available for future use by the DLS because the changed component representation is newer than the cached version of the component, which had previously been compiled into an executable parser. This change in the component therefore triggers the recompilation of the parsers.

In an alternative embodiment, the executable parser is static and never needs recompilation, given a table-driven implementation where component changes merely update a table which is re-read at every invocation of the parser. This alternative embodiment simplifies the implementation considerably but does not materially change the results of operation.

In general, there is a single grammar specification for a given vendor command language. In some cases, there may be separate grammar specifications (and thus separate components) for widely varying versions of a command language. There is considerable variation, however, in support for features of a typical command language across product models, hardware configurations, and software versions.

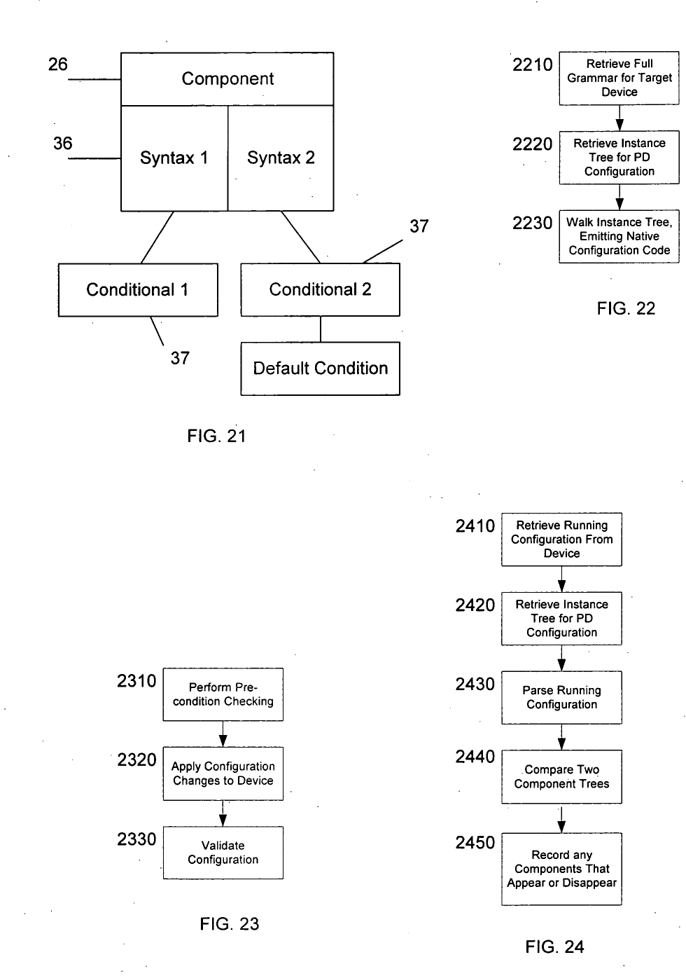

The system handles this kind of variation by allowing a component 26 to possess multiple alternative sets of syntax blocks 36, as shown in FIG. 21. Each alternative set of syntax blocks is associated with a conditional 37, which is a rule of the form “if . . . then” which governs when that syntax block is used. During compilation of a native configuration from a PD configuration 16, the correct syntax block 36 is chosen by determining the most-specific match of device data 12 to the conditions specified in the conditional 37. Typical device data used in conditional rules are metadata such as hardware platform, software version, or physical hardware interface type. At least one syntax block 36 is designated as the “default” implementation, and is used to compile a native configuration whenever there are no matches between device data 12 and conditionals 37.

Component variants can be created by the user, or by Grammar Builder 45 if necessary, and may be created at the desired degree of detail—in other words, it is possible to create a component variant which applies to a single hardware platform, running a specific software version, using specific hardware card types and firmware versions. This kind of specificity is often needed simply to work around bugs and problems in network hardware vendor implementations.

Turning to FIG. 22, native configurations are created by compilation using the device instance tree and the grammar represented by each component's syntax. This compilation process may be performed by the Device Learning System 44, since as noted above, the DLS 44 uses the same lexer and parser to do analysis of native configurations as is used to compile PD configurations 16 into native configurations. During the compilation process, any outstanding data references are resolved, and the final configuration (whether full or incremental) is placed in a staging area (e.g. the device data structure 12) for retrieval and application to the physical device.

The compilation process begins at step 2210 by taking the full grammar composed from all of the stored components (within a given vendor language), and the stored instance tree for the PD configuration 16 for the target device at step 2220. These form inputs to a recursive-descent parser which emits the target configuration language as its “object code.”

In the preferred embodiment, the compiler is written as an LL(0) recursive-descent parser because it is difficult to plug an object tree into a standard off-the-shelf LALR parser (e.g., Bison/yacc) and emit a configuration. In general, the compilation process recursively walks the instance tree at step 2230, emitting literals from the corresponding grammar specification in the case of literal instance data. When object data members are encountered, we track the usage of the reference and only emit syntax corresponding to the data reference once.

In the case of lists, we recurse through the list, keeping a reference to the current position of the output buffer before each recursion step. If a recursion step results in an incomplete output string (i.e., an incomplete vendor command string), we return to the caller and restore the output buffer pointer to the position it held prior to the recursion. This prevents the output of incomplete command strings.

Compilation need not always generate a complete native configuration. In addition to compiling the full configuration for a device, the system generates incremental configurations, which contain only those components and data which are changed since the last configuration event. Compilation can start from any subtree within the PD configuration 16, given an appropriate grammar subtree that contains needed syntax.

Incremental changes to physical devices minimize the impact of changes to unrelated functions and in general increases network stability. Full configuration compilation is still useful, however, for previewing the impact of changes, testing in laboratory contexts and for re-generating a physical device in the event of hardware failure.

Updating physical devices with new configurations is another significant aspect of network control. The exact means used to apply configuration changes varies according to the type of device, and is determined by the features provided by the device vendor.

Turning to FIG. 23, a system in accordance with an embodiment of the invention wraps the device vendor's own mechanisms with a process designed to provide safety for the actual change execution. We treat application of native configurations to a device as a three-stage process. At step 2310, precondition checking is designed to prevent any changes from proceeding in an environment which is not well-controlled, and is equivalent to an airline pilot's “pre-flight check.”

If this check succeeds, at step 2320 we use a software driver which implements a vendor-specific process for applying configuration changes to the device. If errors occur in the application process, the configuration is rolled back to the previously running configuration and the problem reported to the task owner. If no errors occur, we then perform postcondition checks at step 2330, to verify that the device is being left in a functional state.

To be more specific, the download process operates according to a strict contract, modeled after interface contracts in object and component-oriented programming. Changes cannot occur if preconditions are not established, or the results of a change cannot be predicted. And a change cannot be considered complete until postconditions are established.

Precondition checks are performed prior to any software-mediated change to a device configuration. In order for a change to be “safe” to apply, the physical network device must be in a known and predictable state. For example, if the device firmware or operating system version has changed since the last configuration was compiled, our software cannot guarantee that the new configuration will work in a predictable manner.

Thus, precondition checking seeks to establish the “environmental state” of a network device prior to applying a configuration change. We attempt to establish the invariance of:
Hardware platform
Installed hardware if a modular architecture
Operating system software or firmware version
Running configuration version

If any of these environmental factors is different than expected, we do not allow the configuration change or download to proceed. Additionally, we may collect functional data about a device, to aid in the process of assessing proper operation following application of the pending change.

Postcondition checking is different than the precondition test in that we seek to determine whether the network device is functioning properly, following application of a configuration change. When making postcondition checks, we typically seek to establish that interfaces designated as “up” are passing traffic, establish that the routing table differs in “predictable” ways, and so on.

Much of the postcondition functionality checking is implemented as pluggable modules in a scripting language. This allows the system to respond quickly in the face of changes to vendor commands or command output formats, and to allow professional services or third-parties to easily extend this phase of testing.

A complete system for controlling network devices should ensure that network devices continue to implement appropriate policies, even after the configuration is applied and tested. Engineers might change the device configuration manually in the course of troubleshooting or maintenance. More rarely, unauthorized changes can be made, either by employees or by intrusion from outside the customer organization.

The system performs periodic auditing of all production network devices, to detect changes to a network device which did not originate within the change control process of an embodiment of the invention. The auditing interval is configurable, and often will be performed at least once per day (if not more often).

Turning to FIG. 24, basic periodic auditing has five steps. At step 2410, the running configuration for a device 10 is retrieved. The most recent version of the PD configuration 16 is retrieved from the component database 28 in step 2420. This version of the PD configuration 16 is what the system believes should be present on the device, absent any changes from outside sources. At step 2430, the running configuration is passed to the DLS 44 and parsed into a PD configuration 16 as well. Next, in step 2440, the two PD configurations 16 are compared by walking the two trees of instances 20 in tandem, noting any components 26 or policies 34 that occur in one PD configuration but not the other. If the resulting list of missing components 26 or policies 34 is empty, then the network device 10 has not be altered since the last time the system performed a change to its configuration. Otherwise, the list of missing components or policies is stored as the result of the audit, along with the date and time of the audit, for presentation to users within the user interface 40.

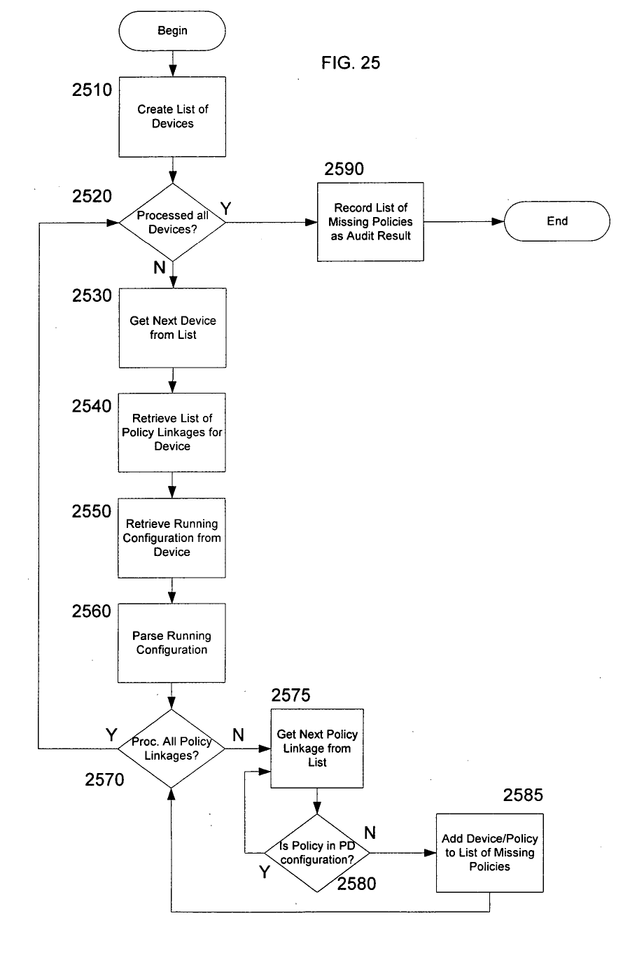

In addition to basic auditing to monitor changes that arise from outside the system, the system monitors the linkage of policies 34 to PD configurations 16 in order to ensure that the design of the network remains as the user intends. This process is depicted in FIG. 25. In step 2510, a list of network devices is created. The system then selects each device in turn (step 2530) until the list is exhausted (step 2520). At step 2540, the list of policy linkages 35 is retrieved, followed by retrieval of the device's running configuration in step 2550. In step 2560, the running configuration is parsed by the DLS 44 into a PD configuration 16. The system them selects each policy linkage 35 for the device in turn (step 2575) until the list for that device is exhausted (step 2570). At step 2580, we examine the PD configuration 16 to determine whether the policy 34 represented by the selected policy linkage 35 is present. If it is present, we simply move on to the next policy linkage. If the policy is not present, we add the policy linkage 35 to a list of missing policies (step 2585). When all devices have been processed in this manner, we record the list of missing policies as the result of the audit (step 2590). An empty list indicates that all policies 34 are present where the users of the system intend them to be. A list with missing policy linkages 35 indicates that some devices have departed (through manual changes or mistakes in editing within the system) from their intended design.

The system incorporates a reporting engine which allows the user to perform standard types of usage reports. Typical reports would be lists of devices requiring updated configurations, the results of basic or policy linkage audits, lists of tasks broken down by user, reports on job and task completion and schedules, and the history of any device, policy, or component in the database. These reporting engines are well-known in the art.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, and the invention can be performed using different or additional process actions, or a different combination or ordering of process actions. Features and processes known to those of ordinary skill in the art of network management systems may similarly be incorporated as desired. Additionally, features may be added or subtracted as desired. The specification and drawings are, accordingly, to be regarded in an illustrative rather than restrictive sense, and the invention is not to be restricted or limited except in accordance with the following claims and their legal equivalents.

1. A network management system for managing a plurality of network devices, comprising:
a device database for storing a native configuration for one of the plurality of network devices;
a component database for storing configuration information used to configure the plurality of network devices, wherein the configuration information is stored as a plurality of components and a plurality of candidate components;
a device learning module for receiving the native configuration from the device database, identifying the configuration information from the native configuration, and storing the configuration information in the component database; and
a grammar builder for receiving a candidate component, resolving the candidate component into a component, and storing the component in the component database.

2. The system of claim 1, wherein the configuration information identified from the native configuration information comprises a policy.

3. The system of claim 2, wherein the policy comprises a plurality of components.

4. The system of claim 2, wherein the policy comprises a template adapted to aggregate together a plurality of components all sharing a common attribute.

5. The system of claim 4, wherein the common attribute comprises membership in a network configuration function for one of the plurality of network devices.

6. The system of claim 1, wherein the plurality of components comprise a policy-driven configuration for one of the plurality of network devices.

7. The system of claim 1, wherein each component comprises a component syntax block.

8. The system of claim 1, wherein each component comprises a configuration command for a configuration command language, the configuration command adapted to configure a function on the network device.

9. The system of claim 1, wherein the configuration information identified from the native configuration information comprises a candidate component.

10. The system of claim 1, wherein the grammar builder receives the candidate component from the device learning module.

11. The system of claim 1, wherein the grammar builder receives the candidate component from the component database.

12. The system of claim 1, wherein the device learning module further comprises a lexer adapted to tokenize the native configuration, and a parser adapted to parse the tokenized native configuration to identify a plurality of components and a candidate component within the tokenized native configuration.

13. The system of claim 12, wherein the parser is configured to identify the plurality of components and the candidate component by comparing the tokenized native configuration to the configuration information stored in the component database.

14. The system of claim 13, wherein the parser is adapted to identify the candidate component by detecting a portion of the tokenized native configuration that does not match the configuration information stored in the component database.

15. The system of claim 13, wherein the parser is adapted to identify the plurality of components by detecting portions of the tokenized native configuration that match the configuration information stored in the component database.

16. The system of claim 12, wherein the lexer is configured to tokenize the native configuration according to a grammar embodied in the configuration information stored in the component database.

17. The system of claim 12, wherein at least a first portion of the lexer and the parser are recompiled each time the device learning module receives a native configuration.

18. The system of claim 17, wherein a second portion of the lexer and the parser remains constant across multiple receptions of native configurations.

19. The system of claim 12, wherein the device learning module further comprises a policy matcher, adapted to parse the plurality of components and recognize a policy contained in the plurality of components.

20. The system of claim 19, wherein the device learning module is adapted to output a policy-driven configuration and zero or more candidate components.

21. The system of claim 1, wherein the device learning module is adapted to compile a policy-driven configuration into a native configuration.

22. The system of claim 1, further comprising a device data storage for storing device-specific information about the plurality of network devices.

23. The system of claim 1, wherein the grammar builder is adapted to retrieve command root completion information from one of the plurality of network devices, create a plurality of command root derived components from the command root completion information, and resolve the candidate component into a component by comparing the candidate component to the plurality of command root derived components, to identify one of the plurality of command root derived components that matches the candidate component.

24. A method of parsing a native configuration into a policy-driven configuration, comprising:
receiving configuration information comprising a plurality of components;
receiving the native configuration;
tokenizing the native configuration using a lexer module;
parsing the tokenized native configuration using a parser module, to identify a plurality of input components contained in the native configuration and match the plurality of input components with the plurality of components;
parsing the tokenized native configuration using the parser module, to identify one or more unknown regions contained in the native configuration, which do not match any of the plurality of components;
emitting a tree of components, comprising the plurality of matched input components and the one or more unknown regions;
processing the one or more unknown regions to identify one or more candidate components;
analyzing the tree of components to identify one or more policies present in the tree of components; and
outputting the one or more policies and the one or more candidate components, as a policy-driven configuration.

25. The method of claim 24, further comprising:
compiling the lexer module using the configuration information, such that the lexer module is adapted to tokenize the native configuration according to a grammar embodied in the configuration information;
compiling the parser module using the configuration information, such that the parser module is adapted to match the tokenized native configuration to the configuration information;

26. The method of claim 24, further comprising reorganizing the tree of components to enhance user comprehension of the tree.

27. The method of claim 24, further comprising compressing the tree to remove unnecessary data from the tree.

28. The method of claim 27, wherein the unnecessary data comprises an empty node in the tree.

29. The method of claim 24, wherein the plurality of components comprises a policy, and analyzing the tree of components comprises:
retrieving the policy;
comparing each of the plurality of components in the policy with the plurality of matched input components contained in the tree of components;
aborting the analysis if any of the plurality of components in the policy is not found in the plurality of matched input components; and
identifying the policy as present in the tree of components if all of the plurality of components in the policy are found in the plurality of matched input components.

30. The method of claim 29, further comprising removing all of the components in the plurality of matched input components that were matched to the plurality of components in the policy, and inserting the policy into the tree of components.

31. The method of claim 29, wherein the policy comprises an ordered policy, and identifying the policy further comprises identifying the ordered policy as present in the tree of components if all of the plurality of components in the ordered policy are found in the plurality of matched input components in the same order as in the ordered policy.

32. The method of claim 24, wherein parsing the tokenized native configuration to identify one or more unknown regions comprises:
detecting a parse error, wherein the parser fails to recognize a portion of the tokenized native configuration;
marking the portion for further processing; and
continuing to parse the tokenized native configuration.

33. The method of claim 24, wherein processing the one or more unknown regions to identify one or more candidate components comprises:
walking the tree of components;
marking each of the plurality of matched input components in the tree of components;
re-walking the tree of components;
identifying a token within one of the one or more unknown regions within the tree of components.
walking the tree of components in each of two directions, beginning at the identified token, to identify a beginning point and an end point of the unknown region; and
marking the unknown region as a candidate component.

34. The system of claim 1, wherein the grammar builder comprises:
a syntax tree acquisition module, configured to receive a command root and output a syntax tree for the command root; and
a syntax tree transformation module, configured to receive the syntax tree and output a grammar based on the syntax tree.

35. The system of claim 34, wherein the syntax tree acquisition module comprises a command root completion module.

36. The system of claim 35, wherein the command root completion module comprises a command help walker.

37. The system of claim 34, wherein the syntax tree transformation module is at least partially vendor-neutral.

38. The system of claim 34, wherein the syntax tree transformation module comprises a syntax tree post-processor.

39. The system of claim 34, further comprising a semantic effect examination module, configured to identify one or more semantic effects triggered by adding or subtracting a component of the grammar, and to catalog the one or more semantic effects in the grammar.

40. The system of claim 39, wherein the semantic effect examination module is configured to catalog the one or more semantic effects by annotating the component that triggers the semantic effect.

41. The system of claim 39, wherein the one or more semantic effects comprise one or more of disappearing default values, equivalent format transformations, linked command appearance, linked command disappearance and unique command parameters.

42. The system of claim 34, wherein the grammar is output in human-readable form.

43. The system of claim 34, wherein the grammar builder is configured to accept a plug-in designed to handle specialized processing needs

44. The system of claim 43, wherein specialized processing needs comprise loop processing.

45. The system of claim 34, wherein the grammar builder is configured to construct both a positive grammar and a negative grammar for the command root.

46. A method of producing a grammar, comprising:
receiving unknown command information;
generating an abstract syntax tree for the unknown command information; and
transforming the abstract syntax tree into a component tree.

47. The method of claim 46, wherein the unknown command information comprises a command root.

48. The method of claim 46, wherein generating an abstract syntax tree comprises walking a command completion feature for the unknown command information.

49. The method of claim 46, further comprising examining the component tree for semantic effects.

50. The method of claim 49, wherein examining the component tree comprises modifying the component tree; applying the modified component tree to a network device; retrieving a native configuration from the network device; and determining whether the native configuration matches the modified component tree.

51. A method of generating a syntax tree for a command for a network device, comprising:
identifying a command root;
providing the command root to the network device;
using a command completion feature on the network device for the command root, to identify a plurality of next completions for the command root;
recursively entering each of the plurality of next completions;
recording in the syntax tree each next completion; and
outputting the syntax tree.

52. The method of claim 51, wherein the command root is identified by receiving a candidate component containing the command root.

53. The method of claim 51, further comprising terminating the recursion step for a branch when a termination character is encountered in the command completion feature.

54. The method of claim 53, wherein the termination character comprises an EOL character.

55. The method of claim 51, wherein entering each of the plurality of next completions further comprises entering a proxy value for a placeholder next completion.

56. The method of claim 51, wherein recording in the syntax tree each next completion further comprises recording metadata about the next completion.

57. The method of claim 51, further comprising handling special processing needs.

58. The method of claim 57, wherein the special processing needs comprise loop processing.

59. A method of transforming a syntax tree including a plurality of syntax nodes into a grammar, comprising:
transforming the plurality of syntax nodes into a plurality of equivalent grammar constructs, resulting in the creation of a grammar;
transforming the grammar to remove unnecessary terminations; and
re-factoring the grammar to remove structural anomalies.

60. The method of claim 59, wherein the transforming step is performed using a plurality of translation rules.

61. The method of claim 59, wherein the syntax tree comprises a plurality of commands and a plurality of termination characters, and wherein transforming the grammar to remove unnecessary terminations comprises ensuring that each command follows a single path in the syntax tree to a single termination character.

62. The method of claim 59, wherein the structural anomalies comprise one or more of common endings, common sub-expressions, orphaned expressions, and repeated segments.

63. The method of claim 59, wherein the syntax tree comprises a command, further comprising:
identifying a plurality of boundaries of the command; and
inserting boundary markers denoting the beginning and end of the command.

64. The method of claim 63, wherein identifying a plurality of boundaries of the command comprises:
receiving a positive grammar for a positive form of the command, the positive grammar comprising a plurality of positive nodes;
receiving a negative grammar for a negative form of the command, the negative grammar comprising a plurality of negative nodes;
walking the plurality of positive nodes;
comparing each of the plurality of positive nodes with a negative node in a corresponding position within the negative grammar;
identifying the two compared nodes as one of the plurality of boundaries for the command if the two compared nodes each comprise a termination character;
marking the plurality of positive nodes walked as being the positive form of the command;
marking the plurality of negative nodes corresponding to the walked plurality of positive nodes as being the negative form of the command; and
merging the marked plurality of positive nodes and marked plurality of negative nodes.

65. The method of claim 64, further comprising walking the plurality of negative nodes.

66. A method of identifying a semantic effect caused by modification of a device configuration on a network device, comprising:
selecting the network device;
retrieving the device configuration from the network device;
storing the device configuration;
modifying the device configuration on the network device;
retrieving the modified device configuration from the network device;
comparing the modified device configuration with the stored device configuration;
identifying a difference between the modified and stored device configurations; and
processing the difference to identify the semantic effect.

67. The method of claim 66, wherein modifying the device configuration comprises adding a command to the device configuration.

68. The method of claim 66, wherein modifying the device configuration comprises removing a command from the device configuration.

69. The method of claim 66, further comprising parsing the stored and modified device configurations into component trees.

70. The method of claim 66, wherein the semantic effect comprises one or more of disappearing default values, equivalent format transformations, linked command appearance, linked command disappearance and unique command parameters.

71. The method of claim 66, further comprising determining an attribute of the device configuration to modify.

72. The method of claim 66, wherein processing the difference comprises identifying a default value.

73. The method of claim 66, wherein processing the difference comprises identifying an equivalent format.

74. The method of claim 67, wherein the device configuration comprises a first instance of a command having a first value for an attribute of the command, the modification comprises adding a second instance of the command, the second instance of the command having a second value for the attribute, and processing the difference comprises:
identifying a number of instances of the command present in the modified device configuration; and
if the number of instances is two, marking the attribute of the command as causing the command to be unique.

75. The method of claim 74, further comprising, if the number of instances is one, marking the attribute of the command as causing the command to be non-unique.

76. The method of claim 67, wherein the difference comprises a second command present in the modified device configuration but not the stored device configuration, and processing the difference to identify the semantic effect comprises recording the second command.

77. The method of claim 67, wherein the difference comprises a second command present in the stored device configuration but not the modified device configuration, and processing the difference to identify the semantic effect comprises recording the second command.

78. The method of claim 68, wherein the difference comprises a second command present in the modified device configuration but not the stored device configuration, and processing the difference to identify the semantic effect comprises recording the second command.

79. The method of claim 68, wherein the difference comprises a second command present in the stored device configuration but not the modified device configuration, and processing the difference to identify the semantic effect comprises recording the second command.

80. A method of compiling a native device configuration for a network device, comprising:
retrieving a full grammar for the network device;
retrieving a policy-driven configuration for the network device;
configuring a parser using the full grammar;
supplying the policy-driven configuration to the parser;
recursively walking the policy-driven configuration to generate the native device configuration.

81. The method of claim 80, wherein a recursion of the recursively walking step is aborted if an incomplete output string is generated for the recursion.

82. The method of claim 80, wherein the policy-driven configuration comprises an incremental configuration.

83. A method of auditing a native configuration running on a network device, comprising:
retrieving the running configuration from the network device;
retrieving a stored configuration corresponding to the running configuration;
comparing the running configuration and the stored configuration; and
recording any differences between the running configuration and the stored configuration.

84. The method of claim 83, wherein the stored configuration comprises an instance tree for a policy-driven configuration, wherein comparing the running and stored configurations comprises comparing the instance tree with a second instance tree, further comprising parsing the running configuration to generate the second instance tree.

85. The method of claim 83, wherein the differences comprise one or more missing policy linkages in the retrieved configuration.

86. The method of claim 83, wherein the differences comprise one or more missing components in one of the retrieved or stored configurations.
